(19) United States
(12) Patent Application Publication
(10) Pub. No.: US 2008/0026662 A1
(43) Pub. Date: Jan. 31, 2008

(54) Flexible Surface Having a UV Curable Waterproofing Composition

(75) Inventor: Sally Judith Weine Ramsey, Tallmadge, OH (US)

Correspondence Address: WILSON SONSINI GOODRICH & ROSATI, 650 PAGE MILL ROAD, PALO ALTO, CA, 94304-1050, US

(73) Assignee: ECOLOGY COATINGS, INC., Akron, OH (US)

(21) Appl. No.: 11/684,502

(22) Filed: Mar. 9, 2007

Related U.S. Application Data
(63) Continuation-in-part of application No. 11/459,876, filed on Jul. 25, 2006.

(51) Int. Cl. D04H 1/00; A01N 25/00

(52) U.S. Cl. 442/376; 424/405; 427/404

(57) ABSTRACT

Disclosed are thixotropic compositions that are curable using ultraviolet and visible radiation. In addition, methods of applying the compositions to fiber substrates such as paper are described, as are methods of curing the coated products. Partially or fully water-resistant articles made using these compositions, such as snow melting mats, windshield protectors, and freezer defrosting sheets are also disclosed.

### CROSS-REFERENCE TO RELATED APPLICATIONS

This application is a Continuation-in-Part of U.S. application Ser. No. 11/459,876, filed Jul. 25, 2006, which is incorporated by reference herein in its entirety.

### FIELD OF THE INVENTION

Described herein are 100% solids, UV curable compositions for use in adhesion, repair and architecture. Also disclosed are articles of manufacture that include the UV curable and/or UV cured compositions described herein.

### BACKGROUND OF THE INVENTION

A variety of consumer, scientific, and industrial products have some type of coating, which has been applied in order to fulfill some expected function, utility and/or appearance. Coating such products with solvent based coatings can be problematic due to environmental issues stemming from evaporation of the volatile solvent. Also, such coatings can require thermal curing, resulting in the need for curing ovens, and the associated energy expenditure to operate them. Adhesives and sealants typically contain volatile solvents that are harmful and/or toxic to the environment and user. Disclosed herein are 100% solids, UV curable compositions for use in architecture, adhesion and repair.

### SUMMARY OF THE INVENTION

Provided herein are compositions that are 100% solids. Compositions provided herein do not include toxic, environmentally harmful, volatile solvents that need to be evaporated and/or driven off to affect curing. Compositions provided herein are thixotropic, with an apparent viscosity at room temperature of about 5000 centipoise. Compositions provided herein are UV curable. Compositions provided herein do not contain any water or organic solvent, which must be removed before complete curing is achieved. Therefore, the compositions provided herein are less hazardous to the environment, and are economical because they require less space, less energy, and less time to cure. Compositions provided herein can be applied to objects as a single coat. In some embodiments, compositions provided can be applied to objects in more than one coat, such as, for example, two coats, or more than two coats. Compositions provided herein lack solvents and are thus considered environmentally friendly. Compositions provided herein do not require thermal curing, or drying stages with coatings of the compositions, and thus there is no need for large ovens, which decreases the space and energy commitment of the coating end-user.

In one aspect is a coated mat comprising:
a sheet of a fibrous substrate;
a coated top layer; and
a coated bottom layer;
wherein the coating comprises:
(a) SiO₂ nano-fillers;
(b) a benzoyldiphenylphosphine oxide photo-initiator and an α-hydroxyketone photo-initiator;
(c) tetrahydrofurfuryl acrylate;
(d) at least one acrylate, methacrylate, diacrylate, dimethacrylate, triacrylate and/or trimethacrylate monomer, wherein the acrylate is other than tetrahydrofurfuryl acrylate, in an amount of about 2% by weight up to about 80% by weight;
(e) a cross-linkable, silicone acrylate, silicone methacrylate, silicone diacrylate, silicone dimethacrylate, silicone triacrylate and/or silicone trimethacrylate;
(f) at least one metal salt comprising:
   a cation selected from among Li⁺, Na⁺, K⁺, Mg²⁺, Ca²⁺, Al³⁺, Zn²⁺, Mn²⁺, and Ag⁺; and
   an anion selected from among F⁻, Cl⁻, Br⁻, I⁻, CO₃²⁻, ClO₄⁻ and NO₃⁻; and
(g) optionally, a pigment, pigment dispersion and/or a third photo-initiator;
wherein the composition is:
   (i) actinic-radiation curable; and
   (ii) thixotropic with an apparent viscosity at room temperature greater than about 5000 centipoise.

In one embodiment is a coated mat wherein the fibrous substrate comprises recycled paper. In another embodiment is a coated mat wherein the coating is impregnated into the fibrous substrate. In a further embodiment is a coated mat comprising silica gel. In yet a further embodiment is a coated mat comprising at least one salt. In one embodiment is a coated mat wherein the at least one salt is selected from the group consisting of NaCl, CaCl₂, MgCl₂, and an organic salt. In another embodiment is a coated mat wherein the organic salt is a carboxylate salt. In another embodiment is a coated mat wherein the coated mat is formed into an item selected from the group consisting of a snow melting mat, a freezer defrosting mat, a windshield cover, and shelf paper.

In one aspect is a method of preparing a mat for melting snow, comprising:

coating or impregnating a mat with UV curable waterproofing formulation comprising:
(a) SiO₂ nano-fillers;
(b) a benzoyldiphenylphosphine oxide photo-initiator and an α-hydroxyketone photo-initiator;
(c) tetrahydrofurfuryl acrylate;
(d) at least one acrylate, methacrylate, diacrylate, dimethacrylate, triacrylate and/or trimethacrylate monomer, wherein the acrylate is other than tetrahydrofurfuryl acrylate, in an amount of about 2% by weight up to about 80% by weight;
(e) a cross-linkable, silicone acrylate, silicone methacrylate, silicone diacrylate, silicone dimethacrylate, silicone triacrylate and/or silicone trimethacrylate;
(f) at least one metal salt comprising:
   a cation selected from among Li⁺, Na⁺, K⁺, Mg²⁺, Ca²⁺, Al³⁺, Zn²⁺, Mn²⁺, and Ag⁺; and
   an anion selected from among F⁻, Cl⁻, Br⁻, I⁻, CO₃²⁻, ClO₄⁻ and NO₃⁻; and
(g) optionally, a pigment, pigment dispersion and/or a third photo-initiator;
wherein the composition is:
   (i) actinic-radiation curable; and
   (ii) thixotropic with an apparent viscosity at room temperature greater than about 5000 centipoise; and

coating at least one side of the mat with a composition comprising:
from about 0% to about 25% powdered silica gel; and
from about 75% to about 100% salt.

In one aspect is a freezer defrosting mat, comprising:

a fibrous substrate;

a coating layer, wherein the coating comprises a UV curable waterproofing formulation comprising:
(a) SiO₂ nano-fillers;
(b) a benzoyldiphenylphosphine oxide photo-initiator and an α-hydroxyketone photo-initiator;
(c) tetrahydrofurfuryl acrylate;
(d) at least one acrylate, methacrylate, diacrylate, dimethacrylate, triacrylate and/or trimethacrylate monomer, wherein the acrylate is other than tetrahydrofurfuryl acrylate, in an amount of about 2% by weight up to about 80% by weight;
(e) a cross-linkable, silicone acrylate, silicone methacrylate, silicone diacrylate, silicone dimethacrylate, silicone triacrylate and/or silicone trimethacrylate;
(f) at least one metal salt comprising:
   a cation selected from among Li⁺, Na⁺, K⁺, Mg²⁺, Ca²⁺, Al³⁺, Zn²⁺, Mn²⁺, and Ag⁺; and
   an anion selected from among F⁻, Cl⁻, Br⁻, I⁻, CO₃²⁻, ClO₄⁻ and NO₃⁻; and
(g) optionally, a pigment, pigment dispersion and/or a third photo-initiator;
wherein the composition is:
   (i) actinic-radiation curable; and
   (ii) thixotropic with an apparent viscosity at room temperature greater than about 5000 centipoise; and

a coating layer comprising at least one salt.

In one embodiment is a freezer defrosting mat wherein the at least one salt is an organic salt.

In one aspect is a vehicle windshield cover to prevent snow or ice buildup, comprising:

a fibrous substrate;

a coating layer, wherein the coating comprises a UV curable waterproofing formulation comprising:
(a) SiO₂ nano-fillers;
(b) a benzoyldiphenylphosphine oxide photo-initiator and an α-hydroxyketone photo-initiator;
(c) tetrahydrofurfuryl acrylate;
(d) at least one acrylate, methacrylate, diacrylate, dimethacrylate, triacrylate and/or trimethacrylate monomer, wherein the acrylate is other than tetrahydrofurfuryl acrylate, in an amount of about 2% by weight up to about 80% by weight;
(e) a cross-linkable, silicone acrylate, silicone methacrylate, silicone diacrylate, silicone dimethacrylate, silicone triacrylate and/or silicone trimethacrylate;
(f) at least one metal salt comprising:
   a cation selected from among Li⁺, Na⁺, K⁺, Mg²⁺, Ca²⁺, Al³⁺, Zn²⁺, Mn²⁺, and Ag⁺; and
   an anion selected from among F⁻, Cl⁻, Br⁻, I⁻, CO₃²⁻, ClO₄⁻ and NO₃⁻; and
(g) optionally, a pigment, pigment dispersion and/or a third photo-initiator;
wherein the composition is:
   (i) actinic-radiation curable; and
   (ii) thixotropic with an apparent viscosity at room temperature greater than about 5000 centipoise; and

a coating layer comprising from about 0% to about 25% powdered silica gel and about 75% to about 100% salt.

In one embodiment is a vehicle windshield cover, further comprising a means to attach the vehicle windshield cover to the windshield. In another embodiment is a vehicle windshield cover wherein the means to attach the vehicle windshield cover is by use of multiple magnets attached near the edges of the windshield cover.

In one aspect is an insect-resistant liner for lining shelves, comprising

a fibrous substrate;

a coating layer, wherein the coating comprises a UV curable waterproofing formulation comprising:
(a) SiO₂ nano-fillers;
(b) a benzoyldiphenylphosphine oxide photo-initiator and an α-hydroxyketone photo-initiator;
(c) tetrahydrofurfuryl acrylate;
(d) at least one acrylate, methacrylate, diacrylate, dimethacrylate, triacrylate and/or trimethacrylate monomer, wherein the acrylate is other than tetrahydrofurfuryl acrylate, in an amount of about 2% by weight up to about 80% by weight;
(e) a cross-linkable, silicone acrylate, silicone methacrylate, silicone diacrylate, silicone dimethacrylate, silicone triacrylate and/or silicone trimethacrylate;
(f) at least one metal salt comprising:
   a cation selected from among Li⁺, Na⁺, K⁺, Mg²⁺, Ca²⁺, Al³⁺, Zn²⁺, Mn²⁺, and Ag⁺; and
   an anion selected from among F⁻, Cl⁻, Br⁻, I⁻, CO₃²⁻, ClO₄⁻ and NO₃—; and
(g) optionally, a pigment, pigment dispersion and/or a third photo-initiator;
wherein the composition is:
   (i) actinic-radiation curable; and
   (ii) thixotropic with an apparent viscosity at room temperature greater than about 5000 centipoise; and

a coating layer comprising
from about 0% to about 100% powdered silica gel;
from about 0% to about 100% borax; and
from about 0% to about 100% boric acid.

In one aspect is a method of deterring insect infestation in shelving, comprising lining the shelving with an insect-resistant liner described herein. In one embodiment is a method of deterring insect infestation in shelving wherein the shelving is foodstuff shelving.

In certain embodiments, provided herein are compositions comprising:
(a) SiO₂ nano-fillers;
(b) a benzoyldiphenylphosphine oxide photo-initiator and an α-hydroxyketone photo-initiator;
(c) tetrahydrofurfuryl acrylate;
(d) an acrylate, methacrylate, diacrylate, dimethacrylate, triacrylate and/or trimethacrylate monomer, wherein the acrylate is other than tetrahydrofurfuryl acrylate, in an amount of about 2% by weight up to about 80% by weight;
(e) a cross-linkable, silicone acrylate, silicone methacrylate, silicone diacrylate, silicone dimethacrylate, silicone triacrylate and/or silicone trimethacrylate;
(f) at least one metal salt comprising: a cation selected from among Li⁺, Na⁺, K⁺, Mg²⁺, Ca²⁺, Al³⁺, Zn²⁺, Mn²⁺, and Ag⁺; and an anion selected from among F⁻, Cl⁻, Br⁻, I⁻, CO₃²⁻, ClO₄ and NO₃—; and
(g) optionally, a pigment, pigment dispersion and/or a third photo-initiator;
wherein the composition is:
   (i) actinic-radiation curable; and
   (ii) thixotropic with an apparent viscosity at room temperature greater than about 5000 centipoise.

In some embodiments, compositions provided herein include SiO₂ nano-fillers at a concentration of about 10% by weight up to about 30% by weight. In other embodiments, compositions provided herein include SiO₂ nano-fillers at a concentration of about 10% by weight up to about 20% by weight. In some embodiments, compositions provided herein include SiO₂ nano-fillers that have a diameter ranging from about 5 nm to about 30 nm, with an average diameter of about 20 nm. In some other embodiments, compositions provided herein include SiO₂ nano-fillers that are colloidal dispersions of SiO₂ in unsaturated (meth-) acrylate monomers. In certain embodiments, compositions provided herein include SiO₂ nano-filler compositions selected from among Nanocryl® C 350, Nanocryl® C 130, Nanocryl® C 140, Nanocryl® C 145, Nanocryl® C 146, Nanocryl® C 150, Nanocryl® C 153, Nanocryl® C 155, and Nanocryl® C 165. In some embodiments, compositions provided herein include Nanocryl® C 155.

In certain embodiments, compositions provided herein include a metal salt of (f) at a concentration of about 0.1% by weight up to about 5% by weight. In some embodiments, compositions provided herein include a metal salt of (f) that comprises a cation selected from among Li⁺ and Ca²⁺. In other embodiments, the metal salt of (f) includes a Li⁺ cation. In some embodiments, the metal salt of (i) includes a Ca²⁺ cation. In some embodiments, compositions provided herein include a metal salt of (f) that comprises an anion selected from among Cl⁻, Br and I⁻. In other embodiments, the metal salt of (f) includes a Cl⁻ anion. In certain embodiments, compositions provided herein include LiCl. In other embodiments, compositions provided herein include CaCl₂. In some embodiments, compositions include LiCl at a concentration of about 0.1% by weight up to about 0.6% by weight. In other embodiments, compositions provided herein include CaCl₂ at a concentration of about 2% by weight up to about 5% by weight.

In certain of the embodiments, compositions provided herein include a benzoyldiphenylphosphine oxide photo-initiator and an α-hydroxyketone photo-initiator. In some embodiments, compositions provided herein include Genocure® LTM and an α-hydroxyketone photo-initiator. In other embodiments, compositions provided herein include Genocure® LTM and 1-hydroxy-cyclohexyl-phenyl-ketone. In other embodiments, compositions provided herein include benzophenone. In some embodiments, compositions provided herein include Genocure® LTM and Igacure® 184. In other embodiments, compositions provided include Genocure® LTM, Irgacure 184® and Irgacure® 500.

In one embodiment, compositions provided herein include tetrahydrofurfuryl acrylate. In some embodiments, compositions provided include at least one additional acrylate, methacrylate, diacrylate, dimethacrylate, triacrylate and/or trimethacrylate monomer, in addition to tetrahydrofurfuryl. In some embodiments, the acrylate, methacrylate, diacrylate, dimethacrylate, triacrylate and/or trimethacrylate monomers that are included into the compositions provided are reactive only at the C═C double bond. In some embodiments, the acrylate, methacrylate, diacrylate, dimethacrylate, triacrylate and/or trimethacrylate monomers that are included into the present compositions are selected from among acrylate ester derivatives, methacrylate ester derivatives, 2-phenoxyethyl acrylate derivatives, and cross-linking acrylate derivatives. In other embodiments, the acrylate, methacrylate, diacrylate, dimethacrylate, triacrylate and/or trimethacrylate monomers are from among acrylate ester derivatives, methacrylate ester derivatives, and cross-linking acrylate derivatives. In some embodiments, compositions provided herein include isobornyl acrylate. In other embodiments, compositions provided herein include 1,4-butanediol dimethacrylate. In still other embodiments, compositions provided herein include 2-phenoxyethyl acrylate. In certain embodiments, compositions provided herein include 1,4-butanediol dimethacrylate and 2-phenoxyethyl acrylate. In certain other embodiments, compositions provided herein include propoxylated glycerol triacrylate. In some embodiments, compositions provided herein include 1,4-butanediol dimethacrylate, 2-phenoxyethyl acrylate and propoxylated glycerol triacrylate. In some other embodiments, compositions provided herein include methyl acrylate. In some embodiments, compositions provided herein include an acrylate, methacrylate, diacrylate, dimethacrylate, triacrylate and/or trimethacrylate, selected from among tetrahydrofurfuryl acrylate, isobornyl acrylate, 1,4-butanediol dimethacrylate, 2-phenoxyethyl acrylate, propoxylated glycerol triacrylate, methacrylate, or combinations thereof. In some embodiments, compositions provided herein include an acrylate, methacrylate, diacrylate, dimethacrylate, triacrylate and/or trimethacrylate, in addition to tetrahydrofurfuryl acrylate, selected from among isobornyl acrylate, 1,4-butanediol dimethacrylate, 2-phenoxyethyl acrylate, propoxylated glycerol triacrylate, methacrylate, or combinations thereof.

In some embodiments, compositions provided herein include at least one cross-linkable, silicone acrylate, silicone methacrylate, silicone diacrylate, silicone dimethacrylate, silicone triacrylate and/or silicone trimethacrylate. In some embodiments, the cross-linkable, silicone acrylate, silicone methacrylate, silicone diacrylate, silicone dimethacrylate, silicone triacrylate and/or silicone trimethacrylate of (e) is a surfactant. In some embodiments, compositions provided include at least one cross-linkable, silicone acrylate, silicone methacrylate, silicone diacrylate, silicone dimethacrylate, silicone triacrylate and/or silicone trimethacrylate selected from among TEGO® Rad 2100, 2200, 2250, 2300, 2500, 2600, 2650, and 2700. In some embodiments, compositions provided herein include TEGO® Rad 2100.

In certain embodiments, compositions provided herein include:

| | | |
|---|---|---|
| tetrahydrofurfuryl acrylate | 11–31% | by weight |
| isobornyl acrylate | 2–22% | by weight |
| 1,4-butanediol dimethacrylate | 3–40% | by weight |
| 2-phenoxyethyl acrylate | 4–40% | by weight |
| Nanocryl ® C-155 | 25–50% | by weight |
| Genocure ® LTM | 0.5–5% | by weight |
| Irgacure ® 184 | 2–10% | by weight |
| Irgacure ® 500 | 0.5–10% | by weight |
| TEGO ® Rad 2100 | 0.01–2.0% | by weight |
| LiCl | 0.1–5% | by weight |

In some embodiments, compositions provided herein include:

| | | |
|---|---|---|
| tetrahydrofurfuryl acrylate | 11–31% | by weight |
| isobornyl acrylate | 2–22% | by weight |
| 1,4-butanediol dimethacrylate | 3–40% | by weight |
| 2-phenoxyethyl acrylate | 4–40% | by weight |
| Nanocryl ® C-155 | 25–50% | by weight |
| Genocure ® LTM | 0.5–5% | by weight |
| Irgacure ® 184 | 2–10% | by weight |
| Irgacure ® 500 | 0.5–10% | by weight |
| TEGO ® Rad 2100 | 0.01–2.0% | by weight |
| CaCl₂ | 0.1–5% | by weight |

In other embodiments, compositions provided herein include:

| | | |
|---|---|---|
| tetrahydrofurfuryl acrylate | 11–31% | by weight |
| isobornyl acrylate | 2–22% | by weight |
| 1,4-butanediol dimethacrylate | 3–40% | by weight |
| 2-phenoxyethyl acrylate | 4–40% | by weight |
| Nanocryl ® C-155 | 25–45% | by weight |
| Irgacure ® 184 | 2–6% | by weight |
| Irgacure ® 500 | 0.5–4.0% | by weight |
| TEGO ® Rad 2100 | 0.01–2.0% | by weight |
| PC 9003 | 1–12% | by weight |
| Lucerin ® TPO | 0.5–5% | by weight |
| Genocure ® LTM | 0.5–5% | by weight |
| LiCl | 0.1–5% | by weight |

In certain embodiments, compositions provided include:

| | | |
|---|---|---|
| tetrahydrofurfuryl acrylate | 11–31% | by weight |
| isobornyl acrylate | 2–22% | by weight |
| 1,4-butanediol dimethacrylate | 3–40% | by weight |
| 2-phenoxyethyl acrylate | 4–40% | by weight |
| Nanocryl ® C-155 | 25–45% | by weight |
| Irgacure ® 184 | 2–6% | by weight |
| Irgacure ® 500 | 0.5–4.0% | by weight |
| TEGO ® Rad 2100 | 0.01–2.0% | by weight |
| PC 9003 | 1–12% | by weight |
| Lucerin ® TPO | 0.5–5% | by weight |
| Genocure ® LTM | 0.5–5% | by weight |
| CaCl₂ | 0.1–5% | by weight |

In other embodiments, compositions provided herein include:

| | | |
|---|---|---|
| tetrahydrofurfuryl acrylate | 20.85% | by weight |
| isobornyl acrylate | 11.64% | by weight |
| 1,4-butanediol dimethacrylate | 12.20% | by weight |
| 2-phenoxyethyl acrylate | 13.24% | by weight |
| Nanocryl ® C-155 | 33.93% | by weight |
| Irgacure ® 184 | 3.34% | by weight |
| Irgacure ® 500 | 1.95% | by weight |
| TEGO ® Rad 2100 | 0.05% | by weight |
| Genocure ® LTM | 2.4% | by weight |
| LiCl | 0.4% | by weight |

In some embodiments, compositions provided herein have an apparent viscosity at room temperature greater than about 5000 centipoise. In some other embodiments, compositions provided herein have an apparent viscosity at room temperature greater than about 6000 centipoise. In other embodiments, compositions provided have an apparent viscosity at room temperature greater than about 8000 centipoise. In some embodiments, compositions provided herein have an apparent viscosity at room temperature greater than about 10,000 centipoise. In some embodiments, compositions provided herein have an apparent viscosity at room temperature greater than about 15,000 centipoise. In some embodiments, compositions provided herein have an apparent viscosity at room temperature greater than about 20,000 centipoise. In some embodiments, compositions provided herein have an apparent viscosity at room temperature greater than about 25,000 centipoise. In some embodiments, compositions provided herein have an apparent viscosity at room temperature greater than about 30,000 centipoise. In some embodiments, compositions provided herein have an apparent viscosity at room temperature greater than about 50,000 centipoise. In some embodiments, compositions provided herein have an apparent viscosity at room temperature greater than about 76,000 centipoise. In some embodiments, compositions provided herein have an apparent viscosity at room temperature greater than about 100,000 centipoise. In some embodiments, compositions provided herein have an apparent viscosity at room temperature greater than about 300,000 centipoise. In some embodiments, compositions provided herein have an apparent viscosity at room temperature greater than about 500,000 centipoise. In some embodiments, compositions provided herein have an apparent viscosity at room temperature greater than about 1,000,000 centipoise.

In some embodiments, compositions provided herein are curable with sunlight. In other embodiments, compositions provided herein are curable with ultra-violet (UV) radiation selected from the group consisting of UV-A radiation, UV-B radiation, UV-C radiation, UV-D radiation, or combinations thereof.

In certain embodiments, provided herein is the use of a composition described herein for coating a non-metal object. In some embodiments, compositions provided herein are impregnated into the surface of the non-metal object. In some embodiments, methods provided herein further include exposing the coated non-metal object to actinic radiation and curing the coated composition. In some embodiments, the actinic radiation used is sunlight. In other embodiments, the actinic radiation used to cure the compositions is ultra-violet (UV) radiation selected from the group consisting of: UV-A radiation, UV-B radiation, UV-C radiation, UV-D radiation, or combinations thereof.

In some embodiments, compositions provided herein are used to coat a non-metal object selected from among glass substrates, polycarbonate substrates, fiber substrates, plastic substrates, ceramic substrates, cement substrates, brick, drywall, stucco, electronic circuitry and computer circuitry.

In certain embodiments, compositions provided herein are used as an adhesive for UV-transparent non-metal objects. In some embodiments, the UV-transparent non-metal object is a glass object. In other embodiments, the UV-transparent non-metal object is a polycarbonate object. In certain embodiments, the use of a composition provided herein as an adhesive for UV-transparent non-metal objects includes: (i) applying a composition provided herein to the UV-transparent non-metal object; (ii) contacting the applied composition on the UV-transparent non-metal object of (i) with a second non-metal object; and (iii) curing the composition with actinic radiation.

In certain embodiments, provided herein is an article of manufacture that comprises: (a) a non-metal object; and (b) a coating of a cured composition provided herein.

In other embodiments, provided herein is an article of manufacture that comprises: (a) a glass object; and (b) a coating of a cured composition provided herein.

In some embodiments, provided herein is an article of manufacture that comprises: (a) a polycarbonate object; and (b) a coating of a cured composition provided herein.

In some other embodiments, provided herein is an article of manufacture that comprises: (a) a fiber object; and (b) a coating of a cured composition provided herein.

In one embodiment, provided herein is a paper product and/or a cellulose-based product that comprises: (a) a paper substrate and/or a cellulose-based substrate; and (b) a composition provided herein.

In some embodiments, compositions provided herein are impregnated into the surface of the paper substrate and/or the cellulose-based substrate. In certain embodiments, the paper product and/or the cellulose-based substrate further includes an additional metal salt in the impregnated composition, wherein the additional metal salt lowers the freezing temperature of water. In some embodiments, the composition is cured in and/or on to the paper substrate and/or on to the cellulose-based substrate. In other embodiments, the paper product and/or the cellulose-based substrate, after exposure to water, exhibits at least one of the following characteristics selected from the group consisting of:
(a) retention of structural strength;
(b) retention of ink or pencil writing;
(c) retention of print;
(d) retention of brightness; and
(e) release of the additional metal salt, which lowers the freezing temperature of water, from the paper product.

In other embodiments, the paper product and/or the cellulose-based substrate, after exposure to water, exhibits at least two of the aforementioned characteristics. In some embodiments, the paper product and/or the cellulose-based substrate, after exposure to water, exhibits at least three of the aforementioned characteristics.

In another embodiment, provided herein is a process of making paper products and/or cellulose-based products, comprising:
(a) providing a paper substrate and/or a cellulose-based substrate;
(b) applying a composition provided herein to the paper substrate and/or the cellulose-based substrate;
(c) optionally adding a metal salt to the applied composition of (b), wherein the metal salt lowers the freezing temperature of water; and
(d) curing the applied composition.

In some embodiments, the composition is partially impregnated into the paper substrate and/or the cellulose-based substrate. In some embodiments, provided herein is a paper product and/or a cellulose-based substrate produced by the above process.

In some embodiments, provided herein is a method of making a 100% solids, UV curable, thixotropic composition, comprising:
(a) mixing at a temperature less than 50° C.:
   (i) SiO₂ nano-fillers;
   (ii) at least one photo-initiator that comprises an α-hydroxyketone;
   (iii) tetrahydrofurfuryl acrylate;
   (iv) an acrylate, methacrylate, diacrylate, dimethacrylate, triacrylate and/or trimethacrylate, wherein the acrylate is other than tetrahydrofurfuryl acrylate, in an amount of about 2% by weight up to about 80% by weight;
   (v) a cross-linkable, silicone acrylate, silicone methacrylate, silicone diacrylate, silicone dimethacrylate, silicone triacrylate and/or silicone trimethacrylate;
   (vi) optionally, a pigment, pigment dispersion and/or an additional photo-initiator;
(b) adding to the mixture of (a):
   (vii) at least one metal salt that comprises:
      a cation selected from among Li⁺, Na⁺, K⁺, Mg²⁺, Ca²⁺, Al³⁺, Zn²⁺, Mn²⁺, and Ag⁺; and
      an anion selected from among F⁻, Cl⁻, Br⁻, I⁻, CO₃²⁻, ClO₄⁻ and NO₃;
   (viii) optionally, Genocure® LTM; and
(c) mixing the mixture for approximately 3-5 hours at a temperature less than 70° C. and at a speed sufficient to ensure an even distribution of the metal salt of (vii) throughout the mixture.

In some embodiments, the method of making 100% solids, UV curable, thixotropic compositions, includes adding less than about 5% by weight of oligomers. In other embodiments, less than about 2.5% by weight of oligomers are added to the compositions provided herein. In some embodiments, less than about 1% by weight of oligomers are added to the compositions provided herein. In other embodiments, less than about 0.5% by weight of oligomers are added to the compositions provided herein. In some other embodiments, the method of making a 100% solids, UV curable, thixotropic composition, does not include adding oligomers.

In some embodiments, the method of making 100% solids, UV curable, thixotropic compositions, includes adding SiO₂ nano-fillers in an amount of about 10% by weight up to about 30% by weight of the total weight of the composition. In other embodiments, SiO₂ nano-fillers are added at a concentration of about 10% by weight up to about 20% by weight of the total weight of the composition. In certain embodiments, SiO₂ nano-fillers are added, which have a diameter ranging from about 5 nm to about 30 nm, with an average diameter of about 20 nm. In some embodiments, SiO₂ nano-fillers are added to the compositions as colloidal dispersions of SiO₂ in unsaturated (meth-)acrylate monomers. In other embodiments, SiO₂ nano-filler compositions are added to the compositions provided herein, such as, for example, SiO₂ nano-filler compositions selected from among Nanocryl® C 350, Nanocryl® C 130, Nanocryl® C 140, Nanocryl® C 145, Nanocryl® C 146, Nanocryl® C 150, Nanocryl® C 153, Nanocryl® C 155, and Nanocryl® C 165. In some embodiments, Nanocryl® C 155 is added to the compositions provided.

In other embodiments, at least one metal salt is added at a concentration of about 0.1% by weight up to about 5% by weight of the total weight of the composition. In some embodiments, the metal salt added to the compositions provided herein include a cation selected from among Li⁺ and Ca²⁺. In certain embodiments, the metal salt added to the compositions provided herein includes a Li⁺ cation. In other embodiments, the metal salt added to the compositions provided herein includes a Ca²⁺ cation. In some other embodiments, the metal salt added to the compositions provided include an anion selected from among Cl, Br⁻ and I⁻. In some embodiments, the metal salt added to the compositions provided include a C⁻ anion. In some embodiments, the metal salt added to the compositions provided is LiCl. In other embodiments, the metal salt added to the compositions provided is CaCl₂. In some embodiments, LiCl is added at a concentration of about 0.1% by weight up to about 0.6% by weight of the total weight of the composition. In other embodiments, CaCl₂ is added at a concentration of about 2% by weight up to about 5% by weight of the total weight of the composition.

In certain embodiments, the method of making 100% solids, UV curable, thixotropic compositions, includes adding an α-hydroxyketone photo-initiator that comprises 1-hydroxy-cyclohexyl-phenyl-ketone. In some embodiments, the method of making 100% solids, UV curable, thixotropic compositions, further includes adding benzophenone. In some embodiments, the α-hydroxyketone photo-initiator that is added includes Igacure® 184. In other embodiments, the α-hydroxyketone photo-initiator(s) added includes Irgacure 184® and Irgacure® 500.

In some embodiments, the method of making a 100% solids, UV curable, thixotropic composition, includes adding an acrylate, methacrylate, diacrylate, dimethacrylate, triacrylate and/or trimethacrylate selected from among isobornyl acrylate, 1,4-butanediol dimethacrylate, 2-phenoxyethyl acrylate, propoxylated glycerol triacrylate, methylacrylate, or combinations thereof.

In some embodiments, the method of making a 100% solids, UV curable, thixotropic composition, includes adding at least one cross-linkable, silicone acrylate, silicone methacrylate, silicone diacrylate, silicone dimethacrylate, silicone triacrylate and/or silicone trimethacrylate. In some embodiments, at least one cross-linkable, silicone acrylate, silicone methacrylate, silicone diacrylate, silicone dimethacrylate, silicone triacrylate and/or silicone trimethacrylate, which is a surfactant, is added to the compositions provided herein. In some embodiments, the cross-linkable, silicone acrylate, silicone methacrylate, silicone diacrylate, silicone dimethacrylate, silicone triacrylate and/or silicone trimethacrylate is added at about 0.01% by weight up to about 2.0% by weight of the total weight of the composition. In other embodiments, the cross-linkable, silicone acrylate, silicone methacrylate, silicone diacrylate, silicone dimethacrylate, silicone triacrylate and/or silicone trimethacrylate is selected from among TEGO® Rad 2100, 2200, 2250, 2300, 2500, 2600, 2650, and 2700. In other embodiments, the cross-linkable, silicone acrylate, silicone methacrylate, silicone diacrylate, silicone dimethacrylate, silicone triacrylate and/or silicone trimethacrylate is TEGO® Rad 2100.

Other uses for the compositions provided herein are described in U.S. patent application Ser. No. 11/234,672, incorporated herein by reference. Compositions provided herein, with or without any added metal salts, can find use in rendering paper and fiber based products resistant to water, see for example, U.S. patent application Ser. No. 11/234,672, incorporated herein by reference. Compositions provided herein, with or without metal salts, find use in adhesion, repair, and architecture. Compositions provided herein, with or without metal salts, find use in adhesion, repair, and architecture of non-metal substrates, to produce non-metal products.

### BRIEF DESCRIPTION OF THE DRAWINGS

FIG. 1 is a schematic drawing of one embodiment of a snow melting mat. The top and bottom sides are indicated.

FIG. 2 is a schematic drawing of one embodiment of a freezer defrosting mat. The top and bottom sides are indicated.

FIG. 3 is a schematic drawing of one embodiment of a window cover. The magnets to attach the cover to the body of a vehicle are indicated.

FIG. 4 is a schematic drawing of one embodiment of shelf paper fabricated using the compositions described herein. The top and bottom sides of the shelf paper are indicated.

### INCORPORATION BY REFERENCE

All publications, patents and patent applications mentioned in this specification are herein incorporated by reference in their entirety to the same extent as if each individual publication, patent or patent application was specifically and individually indicated to be incorporated by reference.

### DETAILED DESCRIPTION OF THE INVENTION

### Certain Terms

Unless defined otherwise, all technical and scientific terms used herein have the same meaning as is commonly understood by one of skill in the art to which the claimed subject matter belongs. All patents, patent applications, published applications and publications, websites and other published materials referred to throughout the entire disclosure herein, unless noted otherwise, are incorporated by reference in their entirety. In the event that there are a plurality of definitions for terms herein, those in this section prevail. Where reference is made to a URL or other such identifier or address, it is understood that such identifiers can change and particular information on the internet can come and go, but equivalent information can be found by searching the internet. Reference thereto evidences the availability and public dissemination of such information.

It is to be understood that both the foregoing general description and the following detailed description are exemplary and explanatory only and are not restrictive of the subject matter claimed. In this application, the use of the singular includes the plural unless specifically stated otherwise. In this application, the use of “or” means “and/or” unless stated otherwise. Furthermore, use of the term “including” as well as other forms, such as “includes,” and “included,” is not limiting.

The section headings used herein are for organizational purposes only and are not to be construed as limiting the subject matter described. All documents, or portions of documents, cited in the application including, but not limited to, patents, patent applications, articles, books, manuals, and treatises are hereby expressly incorporated by reference in their entirety for any purpose.

The term “actinic radiation” as used herein, refers to any radiation source which can produce polymerization reactions, such as, by way of example only, ultraviolet radiation, near ultraviolet radiation, and visible light, such as, for example, sunlight.

As used herein, the term “photo-initiators” refers to compounds that absorb ultra-violet light and use the energy of that light to promote the formation of a dry layer of coating. Photo-initiators in the compositions provide herein, after they absorb ultra-violet light, promote the reaction of monomers with each other and thus aid in the curing process.

As used herein, the term “co-photo-initiator” refers to a photoinitiator which may be combined with another photoinitiator or combination of photoinitiators.

As used herein, the term “cure” refers to polymerization, at least in part, of a coating composition.

As used herein, the term “curable” refers to a coating composition which is able to polymerize at least in part.

As used herein, the term “curing booster” refers to an agent or agents which boost or otherwise enhance, or partially enhance, the curing process.

As used herein, the term “fiber substrates” as used herein, refers to any object which is, contains, or is derived from a natural fiber; such objects encompass (any of the following classifications may overlap with each other):
(a) various types of paper products of any basis weight or grammage, bulk, caliper or thickness, machine and cross direction, smoothness, such as, but not limited to, abrasive paper, absorbent paper, acid free paper, acid proof paper, adhesive paper, air filter paper, air mail paper, album paper, albumin paper, alkaline paper, aluminum foil lamination paper, ammunition paper, anti rust paper, antique paper, archival paper, art paper, asphalt laminated paper, azurelaid paper, bag paper, banknote or currency paper, barograph paper, base paper, bible paper, blade wrapping paper, butcher paper, blotting paper, blueprint paper, board, bond paper, book paper, boxboard, bristol board, business form paper, carbon paper, cardboard, cartridge paper, catalog paper, check or cheque paper, chipboard, cigarette paper, coarse paper (also industrial paper), coffee filter paper, color-fast papers, construction paper, containerboard, copier paper or laser paper, corrugated board, cotton paper or rag paper, cover paper, crepe paper, cut sheet, directory paper, document paper, drawing paper, duplex board, duplex paper, electrical grade paper, envelop paper, fiberboard, filter paper, Fine Papers, Fluorescent Paper, Folding Boxboard, Freesheet, Gasket Board, Glassine Paper, Glazed Paper, Gray Board, Green Paper, Groundwood Papers, Handmade Paper, Index Paper, Industrial Papers, Insulating Board, Ivory Board, Kraft Bag Paper, Kraft Paper, Kraftliner, Label Paper, Laid Paper, Laminated Linerboard, Ledger Paper, Light Weight Paper, Linen Paper, Liner, Linerboard, Manifold Paper, Manila, Mechanical Paper, Millboard, Newsprint, Offset Paper, Packaging Paper, Paperboard, Permanent Paper, Photographic Paper, Poster Paper, Pulp Board, Rag Paper, Rice Paper, Safety Paper, Sanitary Papers, Sanitary Tissue Paper, Security paper, Sized Paper, Solid Fiberboard, Stamp Paper, Strawboard, Tag Paper, Tea Bag Paper, Text Paper, Thin Paper, Tissue, Transparent Paper, Union Kraft, Vegetable Parchment, Vellum Paper, Wall Paper, Water-Color Paper, Waxed Paper, Wrapper, Writing Paper, Yellow Pages, and the like;
(b) cellulose-based products, in which the cellulose is not derived from wood (including are products made from cellulose derived from wood and another source of cellulose);
(c) various types of pulp containing products;
(d) various type of shipping materials, such as, but not limited to, envelopes, bags, boxes, packages, labels, and the like;
(e) various types of marker, such as, but not limited to, garden markers, underwater markers, soil markers, and the like;
(f) various types of natural fiber fabrics, such as, but not limited to, cotton, wool, linen, cashmere, hemp, rampie, silk, and the like;
(g) various types of natural fiber knits, such as, but not limited to, cotton, wool, linen, hemp, rampie, silk, and the like;
(h) fiber substrates which have non-fiber components, such as, but not limited to, buttons, zippers, pins, staples, clips, rods, and the like; and
(i) so-called “renewable products,” that is products made from bio-materials.

As used herein, the term “100% solids UV curable coating” or “100% solids UV curable composition(s)” refers to compositions/coatings that contain no added solvents or water which would require evaporation or to be driven off by heat. As a result, there are no emissions from solvent. No space is required for large ovens. No time is required for evaporation or baking. Energy use is up to 80% lower because heating is unnecessary. With this process, emissions can be lower still, while saving space, time and energy and requiring no final system for pollution control. Furthermore, the process described herein for applying the compositions (i.e. coating, adhesive, sealant) to objects has the ability to reclaim any over-applied, uncured solids.

As used herein, the term “filler” refers to a relatively inert substance, added to modify the physical, mechanical, thermal, or electrical properties of a coating.

As used herein, the term “inorganic pigment’, as used herein, refers to ingredients which are particulate and substantially nonvolatile in use, and includes those ingredients typically labeled as inerts, extenders, fillers or the like in the paint and plastic trade.

As used herein, the term “irradiating” refers to exposing a surface to actinic radiation.

As used herein, the term “milling” refers to the processes of premixing, melting and grinding a powder coating formulation to obtain a powder suitable for spraying.

As used herein, the term “monomers” refers to substances containing single molecules that can link to oligomers and to each other. Monomers, when linked to each other, can form oligomers and polymers.

As used herein, the term “oligomers” refers to molecules containing several repeats of a single molecule. In some cases, oligomers are made up of repeating monomer units, which are covalently linked together. Oligomers typically have molecular weights greater than 1000 daltons.

As used herein, the term “organic salt” typically refers to the reaction product of an organic acid and an inorganic base, such as sodium or potassium. The base can also be an organic base. Examples or organic salts include but are not limited to formate, acetate, propionate, pyruvate, oxalate, malate, tartrate, isocitrate, succinate, glutarate, caproate, benzoate, lactate, citrate, other carboxylates, and the like.

As used herein, the term “polymers” refers to substances containing repeating units of monomers and/or oligomers, which are covalently linked together.

As used herein, the term “polymerizable pigment dispersions” refers to pigments attached to polymerizable resins which are dispersed in a coating composition.

As used herein, the term “polymerizable resin” or “activated resin” refers to resins which possess reactive functional groups.

As used herein, the term “reactive functional group” refers to any chemical functional group that can participate in a chemical reaction with another chemical functional group thus resulting in a covalent chemical bond.

As used herein, the term “pigment” refers to a compound which is insoluble or partially soluble, and is used to impart color.

As used herein, the term “retention of brightness” refers to the ability of a material to retain at least about 90% of its brightness. Retention of brightness prevents discoloration, such as darkening or yellowing, of a material. Representative tests for determining retention of brightness include spectrophotometric tests, such as optical absorption test for brightness (wavelength=457 nm) and/or luminance (wavelength=555 nm), for example.

As used herein, the term “retention of ink or pencil writing” refers to the ability of ink or pencil writing to be at least about 90% retained on a material. Retention of ink or pencil writing prevents bleeding, fading, and/or streaking on a material. Representative tests for determining retention of ink or pencil writing include spectrophotometric tests, such as the Ink Elimination (IE) test and the Effective Residual Ink Concentration (ERIC) test, for example.

As used herein, the term “retention of print” refers to the ability of print to be at least about 90% retained on a material. Representative prints include various ink prints, such as labels, logos, and the like. Retention of print prevents bleeding, fading, and/or streaking on a material. Representative tests for determining retention of print include various spectral photometric tests.

As used herein, the term “retention of structural strength” refers to the ability of a material to retain at least about 90% of its physical and structural integrity, strength, or durability. Retention of structural strength prevents tearing, ripping, or breaks. Representative mechanical tests for determining retention of structural strength include manual inspection, folding endurance, and tensile strength, for example. Spectral photometric tests may also be employed to determine retention of structural strength.

As used herein, the term “retention of writability of pencil and/or ink” refers to the ability of a material to retain at least about 90% of its ability to be written upon by any type of pencil or any source of ink, such as a pen or printer. Writability depends on the absorbency of a material.

As used herein, the term “thixotropic” refers to compositions that show a decrease in apparent viscosity at room temperature when shaken, stirred, agitated and/or sheared. Upon discontinuation of shaking, stirring, agitation and/or shearing, thixotropic compositions revert back to the initial apparent viscosity at room temperature. Thixotropic compositions exhibit a stable form at rest but becoming fluid when shaken, stirred, agitated and/or sheared. For example, thixotropic paint compositions will not run off the painter's brush, but will still spread easily and evenly, since the gel-like paint “liquefies” when brushed out. Compositions, which exhibit the opposite property, in which shaking for a time causes solidification, are called rheopectic.

As used herein, “apparent viscosity” refers to the viscosity of a non-Newtonian fluid measured under specific temperature and shear rate conditions. The viscosity of the compositions described herein are determined using a Brookfield viscometer DV-IILV, spindle #3 at 12 rpm, sample size 150 ml at 21° C.

As used herein, the term “vehicle” refers to the liquid portion of solvent based formulations, and can incorporate both the solvent and the resin.

### Compositions

Compositions provided herein, are useful for coating non-metal substrates, as adhesives, and as sealants. Compositions provided herein are 100% solids UV curable coatings, and thus find use, for example, in a variety of architectural applications. Use of the compositions provided herein as coating materials, as adhesives, as sealing compositions, are curable with actinic radiation to produce novel coatings, adhesive films and seals. Compositions provided herein are useful in combination with a variety of consumer, scientific, and industrial products, which would benefit from a cured coating of a composition provided herein.

Compositions provided herein are useful for rendering non-metal objects resistant to water. In some embodiments, provided herein are non-metal objects that include a cured coating of a composition provided, wherein the cured coated non-metal object exhibits at least one of the following characteristics after exposure to water for at least one day:
(a) retention of structural integrity;
(b) retention of structural strength;
(c) retention of ink, paint or pencil writing;
(d) retention of print;
(e) retention of brightness;
(f) resistance to mold, algae, mildew, bacterial, and/or fungal growth.

In some embodiments, non-metal objects that are coated with a composition provided herein exhibit at least two of the above-mentioned characteristics, at least three of the above-mentioned characteristics, at least four of the above-mentioned characteristics, at least five of the above-mentioned characteristics, or all of the above-mentioned characteristics. Also provided, are non-metal objects that include a cured coat of a composition provided herein that exhibit at least one of the above-mentioned characteristics, at least two of the above-mentioned characteristics, at least four of the above-mentioned characteristics, or all of the above-mentioned characteristics, after exposure to water for at least 2 days, at least 3 days, at least 7 days, and at least 10 days. In some embodiments, exposure to water includes soaking, misting, spraying, seeping, or combinations thereof. Compositions provided herein are useful for water-proofing non-metal objects. In some embodiments, non-metal objects that include a cured coating of a composition provided herein retain desirable aesthetic, performance and durability properties, when exposed to moisture and/or water, including exposure for prolonged periods of time.

Compositions provided herein are 100% solids, UV-curable compositions that find use as, for example, coatings, adhesives, sealants and any other architectural use. Compositions provided herein do not contain any water or organic solvent, which must be removed before complete curing is achieved. Therefore, the compositions provided herein are less hazardous to the environment, and are economical because they require less space, less energy and less time. Compositions provided herein can be used in combination with thermally sensitive substrates.

Coating materials, following their application to materials, are required to exhibit very good stability in order that they permit the production of comparatively thick coating films and/or coats without exhibiting the extremely disruptive running, especially on vertical surfaces and/or substrates. The viscosity of the coating materials, such as, for example, the compositions provided herein, must not be so high that problems arise during application and the applied coating films and/or coats are no longer able to flow out effectively. Coats, such as, for example, clearcoats, should posses favorable properties such as gloss, transparency and clarity, scratch resistance, weathering stability, and yellow stability. The aforementioned properties of coating materials are desirable for adhesive films and seals.

Thixotropic compositions provided herein have very good application properties, very good stability, and very good flow, which produces coats upon UV curing, which have favorable properties such as gloss, transparency and clarity, scratch resistance, weathering stability, and yellowing stability.

Provided herein are composition that are:
(a) thixotropic with an apparent viscosity greater than about 5000 centipoise at room temperature; and
(b) are actinic radiation curable.

Compositions provided herein are thixotropic, exhibiting a stable form at rest but becoming fluid when agitated, shaken, mixed and/or sheared. The agitated, shaken, mixed and/or sheared fluid compositions revert back to their stable form at rest in the absence of agitation, shaking, mixing and/or shearing after an amount of time. In certain embodiments, compositions provided herein are thixotropic, with an apparent viscosity greater than about 5000 centipoise at room temperature. In some embodiments, compositions provided herein are thixotropic, with an apparent viscosity greater than about 6000 centipoise; about 7000 centipoise; about 8000 centipoise; about 9000 centipoise; about 10,000 centipoise; about 11,000 centipoise; about 12,000 centipoise; about 13,000 centipoise; about 14,000 centipoise; about 15,000 centipoise; about 16,000 centipoise; about 17,000 centipoise; about 18,000 centipoise; about 19,000 centipoise; about 20,000 centipoise; about 25,000 centipoise; or greater than about 30,000 centipoise at room temperature. In some embodiments, compositions provided herein have an apparent viscosity at room temperature greater than about 50,000 centipoise. In some embodiments, compositions provided herein have an apparent viscosity at room temperature greater than about 76,000 centipoise. In some embodiments, compositions provided herein have an apparent viscosity at room temperature greater than about 100,000 centipoise. In some embodiments, compositions provided herein have an apparent viscosity at room temperature greater than about 300,000 centipoise. In some embodiments, compositions provided herein have an apparent viscosity at room temperature greater than about 500,000 centipoise. In some embodiments, compositions provided herein have an apparent viscosity at room temperature greater than about 1,000,000 centipoise.

Compositions provided herein, are thixotropic with an apparent resting-state viscosity suitable for providing a stable, non-flowing composition, which becomes fluid when agitated, shaken, mixed and/or sheared, thus allowing the composition to be applied to the surfaces of materials as coats, as adhesives and/or as sealants. The compositions provided herein, after they have been agitated, shaken, mixed and/or sheared, and then applied to the surfaces of non-metal substrates, revert back to the resting-state viscosity, producing non-flowing coats that can then be cured with actinic radiation to produce non-metal products that include a cured composition provided herein.

In one embodiment, the compositions provided herein include:
(a) SiO₂ nano-fillers;
(b) a benzoyldiphenylphosphine oxide photo-initiator and an α-hydroxyketone photoinitiator;
(c) tetrahydrofurfuryl acrylate;
(d) an acrylate, methacrylate, diacrylate, dimethacrylate, triacrylate and/or trimethacrylate, wherein the acrylate is other than tetrahydrofurfuryl acrylate and is present at a concentration of about 2% by weight up to about 80% by weight;
(e) a cross-linkable, silicone acrylate, silicone methacrylate, silicone diacrylate, silicone dimethacrylate, silicone triacrylate and/or silicone trimethacrylate;
(f) at least one metal salt including:
   a cation selected from among Li⁺, Na⁺, K⁺, Mg²⁺, Ca²⁺, Al³⁺, Zn²⁺, Mn²⁺, Ti²⁺, Ti³⁺, Ti⁴⁺, Co²⁺, Co³⁺, Sc³⁺ and Ag⁺;
   an anion selected from among F⁻, Cl⁻, Br⁻, I⁻, CO₃², ClO₄⁻ and NO₃⁻; and
   (g) optionally, a pigment, pigment dispersion and/or a third photo-initiator.

In one embodiment, compositions provided herein are applied to glass objects, polycarbonate objects, ceramic objects and non-metal objects. In one embodiment, compositions provided herein are applied to fiber substrates to produce fiber products having desirable properties. In another embodiment, the compositions provided herein, are applied to glass objects, polycarbonate objects, ceramic objects, non-metal objects and fiber objects and exposed to actinic radiation in order to cure the applied compositions.

In one embodiment, compositions provided herein include SiO₂ nano-fillers in an amount of about 10% by weight up to about 30% by weight of the total weight of the composition (wt/wt). In certain embodiments, compositions provided herein include at least one benzoyldiphenylphosphine oxide photo-initiator in an amount of 0.1% by weight up to about 2% by weight. In a further embodiment, the compositions provided herein include Genocure® LTM in an amount of 0.5% by weight up to about 5% by weight. In certain embodiments, compositions provided herein include at least one α-hydroxyketone photo-initiator in an amount of about 1% by weight up to about 6% by weight. In some embodiments, the compositions provided herein include benzophenone in an amount ranging from about 0.5% by weight up to about 2% by weight. In further or alternative embodiments, compositions provided herein include tetrahydrofurfuryl acrylate in an amount of 10% by weight up to about 30% by weight. In some embodiments, the composition provided include at least one acrylate, methacrylate, diacrylate, dimethacrylate, tiacrylate and/or trimethacrylate, wherein the acrylate is other than tetrahydrofurfuryl acrylate, in an amount of about 2% by weight up to about 80% by weight. In another embodiment, the compositions provided herein include a cross-linkable, silicone acrylate, silicone methacrylate, silicone diacrylate, silicone dimethacrylate, silicone triacrylate and/or silicone trimethacrylate in an amount of about 0.01% by weight up to about 2.0% by weight. In certain embodiments, the compositions provided herein include a pigment or pigment dispersion in an amount of about 1% by weight up to about 12% by weight.

Compositions described herein can be applied to a variety of substrates, including, for example, glass substrates, polycarbonate substrates, ceramic substrates, non-metal substrates and fiber substrates to produce glass products, polycarbonate products, ceramic products, non-metal products and fiber products. Compositions described herein can be applied to a variety of substrates, including, for example, glass substrates, polycarbonate substrates, ceramic substrates, non-metal substrates and fiber substrates, and then cured with actinic radiation to produce glass products, polycarbonate products, ceramic substrates, non-metal products and fiber products. Compositions described herein are curable by actinic radiation, such as, for example, various sources of visible radiation, near visible radiation, ultra-violet (UV) radiation, and combinations thereof. UV radiation can be selected from the group consisting of UV-A radiation, UV-B radiation, UV-C radiation, UV-D radiation, or combinations thereof. Compositions described herein are curable by sunlight.

Coating the surfaces of various objects with solvent based coatings can be problematic due to environmental issues stemming from evaporation of the volatile solvent. Also, such solvent based coatings can require thermal curing, resulting in the need for curing ovens and the associated energy expenditure to operate them. Compositions provided herein are cured by actinic radiation. Compositions provided herein do not require thermal curing. In one embodiment, compositions provided herein are cured by actinic radiation, such as, for example, sunlight. In some embodiments, compositions provided herein are applied to non-metal objects, such as, for example, glass, polycarbonate, ceramic, brick, cement, stucco, drywall, fiber substrates, wood, paper, or any other suitable non-metal material on the outside of a building or home, and then cured with sunlight. Compositions provided herein are curable by sunlight in a matter of hours in cold temperatures, such as, for example, winter weather, without any need for thermal curing. In other embodiments, compositions provided herein can be used as sealants. In certain embodiments, compositions provided herein are used to coat computer circuitry or electronic circuitry, in order to render the circuitry resistant to water and/or to preserve the existing print on the circuitry and/or preserve thermal conductivity without compromising clarity.

Coating flexibility may be an important characteristic for compositions herein when applied to objects which flex, distort, or otherwise change shape, such as, but not limited to, fabrics and cloths. Coating flexibility allows the composition to flex or distort without cracking when the object flexes, distorts or changes shape; whereas coating adhesion properties allows the coating to remain attached to the object when the object flexes, distorts or changes shape. Certain embodiments of the compositions described herein may be used to obtain and optimize desirable properties.

### Nano-Fillers

In some embodiments, compositions provided herein include silicon dioxide (SiO₂) nano-fillers (nano-silicon dioxide). Silicon dioxide nano-fillers having a nanometer size, including by way of example, silicon dioxide particles with a diameter less than about 200 nm, and by way of further example, a diameter ranging from about 5 nm to about 40 nm, can be incorporated into compositions provided herein. Addition of silicon dioxide nano-fillers to the compositions provided herein may impart improved toughness, hardness and abrasion and scratch resistance. Other properties and features obtained when incorporating silicon dioxide nano-fillers into compositions provided herein can include: it acts as a barrier effect against gases, water vapor and solvents; it has increased weathering resistance and inhibited thermal aging; it exhibits reduced cure shrinkage and heat of reaction, reduced thermal expansion and internal stresses, increased tear resistance, fracture toughness and modulus, has improved adhesion to a large number of inorganic substrates (e.g., glass, aluminum), has improved dirt resistance against inorganic impurities (e.g., soot) by a more hydrophilic surface, and has improvements to other desired properties such as: thermal stability, stain-resistance, heat conductivity, dielectric properties.

Compositions that incorporate silicon dioxide nano-fillers find use in abrasion resistant coating applications requiring superior optical transparency such as eye glasses; fine polishing applications, including semiconductors; and nanocomposite applications, including improved thermal management. In addition, incorporation of silicon dioxide nano-fillers can give rise to compositions with improved impact resistance, abrasion resistance and scratch resistance.

Silicon dioxide nano-fillers are commercially available as compositions that include silicon dioxide nanoparticles in acrylate monomers, methacrylate monomers, acrylate oligomers and/or methacrylate oligomers. Representative silicon dioxide nano-filler compositions include those sold under the name Nanocryl® C by Hanse Chemie (Geesthacht, Germany). Nancryl® C products are colloidal dispersions of up to 50% by weight of amorphous silica in a wide range of conventional unsaturated (meth-)acrylate monomers and oligomers. The dispersed phase consists of surface-modified, spherically shaped SiO₂ nanoparticles having a diameter ranging from about 5 nm up to about 30 nm, with an average diameter of about 20 nm. In some embodiments, the silicon dioxide nano-fillers in the compositions provided herein include those such as, for example, Nanocryl® C 350, Nanocryl® C 130, Nanocryl® C 140, Nanocryl® C 145, Nanocryl® C 146, Nanocryl® C 150, Nanocryl® C 153, Nanocryl® C 155, and Nanocryl® C 165. In certain embodiments, the compositions provided herein include Nanocryl® C 155.

The average particle size of nano-fillers in the compositions described herein include, by way of example, less than about 200 nm, and by way of further example, with an average particle size about 5 nm up to about 50 nm. In some embodiments, nano-filler particles in the compositions provided herein have an average diameter of about 10 mm, about 20 mm, about 30 nm, or about 40 nm. In another embodiment, the nano-filler particles have a diameter about 1 nm up to about 60 mm, such as, for example, a diameter of about 5 nm up to about 30 nm.

Nano-fillers are present in the compositions provided herein in an amount ranging from about 10% by weight up to about 30% by weight (wt/wt), such as from about 10% by weight up to about 25% by weight, from about 10% by weight up to about 20% by weight, or from about 10% by weight up to about 18% by weight. In some embodiments, the compositions provided herein include nano-fillers in an amount from about 13% by weight up to about 18% by weight. In some embodiments, the nano-fillers are SiO₂ nano-fillers.

Nano-filler compositions, such as, for example, Nanocryl® C compositions, are present in the compositions provided herein in an amount ranging from about 20% by weight up to about 60% by weight, such as from about 25% by weight up to about 55% by weight, from about 25% by weight up to about 50% by weight, from about 25% by weight up to about 40% by weight, or from about 25% by weight up to about 35% by weight. In some embodiments, the present compositions include a Nanocryl® C composition from about 30% by weight up to about 36% by weight. In some embodiments, the compositions provided herein include a Nanocryl® C composition selected from among Nanocryl® C 350, Nanocryl® C 130, Nanocryl® C 140, Nanocryl® C 145, Nanocryl® C 146, Nanocryl® C 150, Nanocryl® C 153, Nanocryl® C 155, Nanocryl® C 165. In certain embodiments, compositions provided herein include Nanocryl® C 155. In some embodiments, the compositions provided herein include a combination of Nanocryl® C compositions. In some embodiments, compositions provided herein include at least one Nanocryl® C composition. In certain embodiments, compositions provided herein include one Nanocryl® C composition.

The addition of fillers imparts certain rheological properties to the composition, such as, for example, viscosity; however, the addition of nanoscale fillers (nano-fillers) imparts dramatically different effects on the coating mechanical properties in comparison to micron-scale fillers. Thus, the mechanical properties of the composition can be manipulated by varying the amount of micron-sized fillers and nano-fillers. In some embodiments, compositions provided herein include a combination of micron-sized fillers and nano-fillers. In certain embodiments, compositions provided herein include nano-fillers. In certain embodiments, compositions provided herein include a combination of nano-fillers.

Improved properties attributable to nano-fillers include improved tensile strength, modulus, heat distortion temperature, barrier properties, UV resistance, abrasion and scratch resistance, and conductivity. The incorporation of certain nano-fillers, such as, for example, nano-silicon, can provide favorable long-term coating without significantly effecting optical clarity, gloss, color or physical properties. These improved properties may be in large part due to the small size and large surface area of the nanoscale fillers.

### Photo-Initiators

In certain embodiments, compositions provided herein include at least one photo-initiator. In certain embodiments, compositions provided herein include at least two photo-initiators. In some embodiments, compositions provided herein include at least three photo-initiators. In some embodiments, compositions provided herein include at least four photo-initiators.

Compositions provided herein include at least one photo-initiator. In some embodiments, compositions provided herein include a combination of photo-initiators. In some embodiments, compositions provided herein include at least one photo-initiator selected from among phosphine oxide photo-initiator(s), α-hydroxyketone photo-initiator(s), benzophenone or substituted benzophenones, tertiary amine photo-initiator(s), thioxanthone(s), Norish Type I photo-initator(s) Norish Type II photo-initator(s), and/or transition metal based photo-initiator(s).

In some embodiments, compositions provided herein include at least one benzoyldiphenylphosphine oxide photo-initiator and at least one α-hydroxyketone photo-initiator. In some embodiments, compositions provided herein include at least one benzoyldiphenylphosphine oxide photo-initiator, at least one α-hydroxyketone photo-initiator and benzophenone. In some embodiments, compositions provided herein include Genocure® LTM and an α-hydroxyketone photo-initiator. In some other embodiments, compositions provided herein include Genocure® LTM, an α-hydroxyketone photo-initiator, and benzophenone. In certain embodiments, compositions provided herein include at least one phosphine oxide photo-initiator, such as, for example, mono-acylphosphine oxides and/or bis-acylphosphine oxides.

Generally, photo-initiators are added to initiate rapid polymerization of monomers in the composition upon exposure to a source of actinic radiation, such as, for example, ultraviolet light. The photo-initiator(s) can be matched to the spectral properties of the UV source, such as, for example, medium pressure mercury arc lights which produce intense UV-C (200-280 nm) radiation, doped mercury discharge lamps which produce LV-A (315-400 nm) radiation, or UV-B (280-315 nm) radiation depending on the dopant, or combination of lamp types. Depending on the photo-initiator or combination of photo-initiators in the compositions, varying UV source(s) may be employed. Photo-initiators provided herein can initiate rapid polymerization of monomers upon exposure to a source of actinic radiation. In some embodiments, photo-initiators provided herein can initiate rapid polymerization of monomers upon exposure to a source of actinic radiation, such as, for example, sunlight.

Any suitable type of photo-initiator(s) may be used in the compositions, including those categorized as free radicals. The photo-initiator(s) may be in liquid or solid form. Furthermore, combinations of photo-initiators may be used which encompass different spectral properties of the UV sources used to initiate polymerization.

In certain embodiments, the photo-initiators present in the compositions provided herein are selected from among phosphine oxide type photo-initiators, α-hydroxyketone photo-initiators, benzophenone photo-initiators, and combinations thereof. In certain embodiments, the photo-initiator(s) present in the compositions provided herein may be selected from among GENOCURE® LTM (Rahn USA Corporation, 1005 North Commons Drive, Aurora, Ill.), diphenyl(2,4,6-trimethylbenzoyl)phosphine oxide, benzophenone, ESACURE® KTO, IRGACURE® 184, IRGACURE® 500, DARACUR® 1173, Lucirin® TPO, 1-hydroxycyclohexyl phenyl ketone, (2-hydroxy-2-methyl-1-phenyl-propan-1-one), (2,4,6-trimethylbenzophenone), 4-methylbenzophenone, phosphine oxide type photoinitiators, oligo(2-hydroxy-2-methyl-1-(4-(1-methylvinyl)phenyl)propanone), and combinations thereof. In another embodiment, compositions provided herein include photo-initiator(s) selected from among phosphine oxide type photoinitiators, GENOCURE® LTM, diphenyl-(2,4,6-trimethylbenzoyl)phosphine oxide, benzophenone, 1-hydroxycyclohexyl phenyl ketone, IRGACURE® 184, IRGACURE® 500, 2-hydroxy-2-methyl-1-phenyl-propan-1-one (DAROCUR® 1173 from Ciba Specialty Chemicals 540 White Plains Road, Tarrytown, N.Y., U.S.A.)), (2,4,6-trimethylbenzophenone), 4-methylbenzophenone, ESACURE® KTO 46 (Lamberti S.p.A., Gallarate (VA), Italy), oligo(2-hydroxy-2-methyl-1-(4-(1-methylvinyl)phenyl)propanone), amine acrylates, thioxanthones, benzyl methyl ketal, and mixtures thereof. In a further embodiment, compositions provided herein include photo-initiators selected from among 2-hydroxy-2-methyl-1-phenyl-propan-1-one (DAROCUR® 1173), phosphine oxide type photoinitiators, GENOCURE® LTM, diphenyl-(2,4,6-trimethylbenzoyl)phosphine oxide, IRGACURE® 184, IRGACURE® 500, IRGACURE® 819, IRGACURE® 1700 (Ciba Specialty Chemicals 540 White Plains Road, Tarrytown, N.Y., U.S.A.), amine acrylates, thioxanthones, benzyl methyl ketal, and mixtures thereof.

Other photo-initiators, which are suitable for use in the compositions provided herein, include, but are not limited to, 1-phenyl-2-hydroxy-2-methyl-1-propanone, oligo {2-hydroxy-2-methyl-1,4-(methylvinyl)phenylpropanone)}, 2-hydroxy-2-methyl-1-phenylpropan-1-one, bis(2,6-dimethoxybenzoyl)-2,4,4-trimethylpentyl phosphine oxide, 1-hydroxycyclohexyl phenyl ketone and benzophenone, as well as mixtures thereof. Still other useful photo-initiators for use in the compositions provided herein include, for example, bis(η⁵-cyclopentadienyl)-bis-(2,6-difluoro-3-(1H-pyrol-1-yl)phenyl)titanium (IRGACURE® 784) and 2-benzyl-2-dimethylamino-1-(4-morpholinophenyl)-1-butanone (IRGACURE® 369). While, still other useful photoiniators include, for example, 2-methyl-1,4-(methylthio)-2-morpholinopropan-1-one, 4-(2-hydroxy)-phenyl-2-hydroxy-2-(methylpropyl)ketone, 1-hydroxy-cyclohexylphenyl ketone, benzophenone, (cyclopentadienyl)(1-methylethyl)benzene-iron hexafluorophosphate, (2,2-dimethoxy-2-phenyl-1-acetophen-one), (2,4,6-trimethylbenzoyl-diphenyl phosphine oxide), benzoic acid, 4-(dimethylamino)-ethyl ether, as well as mixtures thereof.

In certain embodiments, compositions provided herein include at least Genocure® LTM and at least one α-hydroxyketone photo-initiator, such as, for example, 1-hydroxy-cyclohexyl-phenyl-ketone. In certain embodiments, compositions provided herein include at least one α-hydroxyketone photo-initiator. In some embodiments, compositions provided herein include at least one α-hydroxyketone photo-initiator and benzophenone. In certain embodiments, compositions provided herein include at least one phosphine oxide photo-initiator and at least one α-hydroxyketone photo-initiator, such as, for example, 1-hydroxy-cyclohexyl-phenyl-ketone. In some embodiments, compositions provided herein include at least three initiators, such as, for example, Genocure® LTM, at least one α-hydroxyketone photo-initiator, such as, for example, 1-hydroxy-cyclohexyl-phenyl-ketone, and benzophenone. In certain embodiments, compositions provided herein include at least three photo-initiators, such as, for example, at least one phosphine oxide photo-initiator, at least one α-hydroxyketone photo-initiator, such as, for example, 1-hydroxy-cyclohexyl-phenyl-ketone, and benzophenone. In certain embodiments, the compositions provided herein include benzophenone. In another or alternative embodiment, compositions provided herein include at least one benzoyl diaryl phosphine photo-initiator, such as, for example, trimethylbenzoyldiphenylphosphine oxide. In some embodiments, the compositions provided herein include at least one α-hydroxyketone photo-initiator, such as, for example, 1-hydroxy-cyclohexyl-phenyl-ketone.

In certain embodiments, compositions provided herein include a combination of photo-initiators. In some embodiments, compositions provided herein include GENOCURE® LTM, IRGACURE® 184 and IRGACURE® 500. In another embodiment, compositions provided herein include GENOCURE® LTM, IRGACURE® 184, IRGACURE® 500, and Lucirin® TPO.

Depending on the required film thickness of the compositions provided herein, the amount of photo-initiator(s) may be increased or adjusted accordingly. Generally, for thinner films, larger amounts of photo-initiator(s) are required. In some embodiments, faster curing is achieved by using a combination of photo-initiators. Compositions provided herein include photo-initiators in an amount ranging from about 0.5% by weight up to about 10% by weight. In some embodiments, compositions provided herein include photo-initiator(s) in an amount ranging from about 1% by weight up to about 9% by weight, from about 3% by weight up to about 8% by weight, from about 4% by weight up to about 8% by weight, or from about 5% by weight up to about 8% by weight.

In certain embodiments, compositions provided herein include a combination of photo-initiators, wherein each photo-initiator is present in an amount ranging from about 0.01% by weight up to about 5% by weight, such as from about 0.1% by weight up to about 4% by weight or from about 0.5% by weight up to about 4% by weight. In some embodiments, compositions provided herein include GENOCURE® LTM in an amount ranging from about 0.5% by weight up to about 4% by weight, such as from about 1% by weight up to about 3% by weight, such as about 1% by weight, about 1.5% by weight, about 2% by weight, about 2.5% by weight or about 3% by weight. In some embodiments, compositions provided herein include IRGACURE® 184 in an amount ranging from about 2% by weight up to about 6% by weight, such as about 2% by weight, about 2.5% by weight, about 3% by weight, about 3.5% by weight, about 4% by weight, about 4.5% by weight, about 5% by weight, or about 6% by weight. In some embodiments, compositions provided herein include IRGACURE® 500 in an amount ranging from about 0.5% by weight up to about 4% by weight, such as about 0.5% by weight, about 1% by weight, about 1.5% by weight, about 2% by weight, about 2.5% by weight, about 3% by weight, about 3.5% by weight or about 4% by weight.

In some embodiments, compositions provided herein include trimethyl-benzoyldiphenylphosphine oxide in an amount of about 0.01% by weight up to about 1% by weight, such as about 0.1%, about 0.2%, about 0.4%, about 0.6%, about 0.8% or 1% by weight. In some embodiments, compositions provided herein include an α-hydroxyketone photo-initiator in an amount ranging from about 2% by weight up to about 6% by weight, such as about 2% by weight, about 2.5% by weight, about 3% by weight, about 3.5% by weight, about 4% by weight, about 4.5% by weight, about 5% by weight, or about 6% by weight. In some embodiments, compositions provided herein include benzophenone in an amount ranging from about 0.25% by weight up to about 2% by weight, such as about 0.25% by weight, about 0.5% by weight, about 0.75% by weight, about 1% by weight, about 1.25% by weight, about 1.5% by weight, about 1.75% by weight or about 2% by weight.

In some embodiments, compositions provided herein include a pigment, or pigment dispersion in combination with a phosphine oxide photo-initiator, such as, for example, a benzoyldiarylphosphine oxide photo-initiator. Although the presence of pigments and/or pigment dispersions can absorb actinic radiation both in the UV and visible light regions and reduce the effectiveness of some types of photo-initiators, phosphine oxide type photo-initiators are effective in pigmented composition, including, by way of example only, black and colored UV-curable coating materials. Phosphine oxides also find use as photo-initiators for white coatings. In some embodiments, compositions provided herein include a pigment and/or pigment dispersion and at least one trimethylbenzoyl-diphenylphosphine oxide photo-initiator, such as, for example, phosphine oxide photo-initiators sold under the tradename GENOCURE® LTM or Lucirin® TPO.

In certain embodiments, compositions provided herein include at least one benzoyldiaryl phosphine oxide photo-initiator in an amount ranging from about 0.01% by weight up to about 5%, from about 0.01% by weight up to about 4% by weight, from about 0.05% by weight up to about 3% by weight, from about 0.1% by weight up to about 2% by weight, from about 0.5% by weight up to about 3% by weight, or from about 1% by weight up to about 3% by weight. In certain embodiments, compositions provided herein include at least one benzoyldiarylphosphine oxide photo-initiator in an amount of about 0.01% by weight, about 0.05% by weight, about 0.1% by weight, 0.5% by weight, about 1% by weight, about 2% by weight, about 3% by weight, or about 4% by weight.

### Monomers

In some embodiments, compositions provided herein include at least one mono-functional monomer. In some embodiments, compositions provided herein include acrylate and/or methacrylate type monomers. In certain embodiments, compositions provided herein include acrylate and/or methacrylate type monomers that are reactive at the C═C double bond of the acrylate and/or methacrylate moiety of the monomer molecule. In certain embodiments, the present compositions include a combination of monomers. Upon exposure to a source of actinic radiation, such as ultraviolet light, and in the presence of a photo-initiator, monomers in the compositions provided herein are rapidly polymerized to form polymers and/or oligomers.

The mechanical properties of the present compositions, such as hardness, low shrinkage, high glass transition temperatures (T_{g}), desirable elasticity, and flexibility depend upon the type of monomers that are included the compositions. By way of example only, polyester acrylates combine good abrasion resistance with toughness, whereas urethane acrylates and polyether acrylates can provide flexibility, elasticity and hardness. Thus, the composition described herein combine monomers which impart various properties to obtain compositions that are hard, abrasion resistant, scratch resistant, and impact resistant.

In certain embodiments, compositions described herein include at least one reactive monomer that produces polymers through the formation of free radicals when exposed to a source of actinic radiation, such as ultraviolet light. In certain embodiments, compositions described herein include a combination of reactive monomers that produces polymers through the formation of free radicals when exposed to a source of actinic radiation, such as, for example, ultraviolet light. In some embodiments, the reactive monomers provided herein produce polymers through the formation of free radicals when exposed to a source of actinic radiation through the aid of photo-initiators.

Reactive monomers suitable for incorporation into the present compositions exhibit at least one of the following properties: (a) high UV reactivity; (b) low shrinkage; (c) good balance of hardness and flexibility; (d) high UV stability after polymerization; (e) good viscosity reduction; and/or (f) low toxicity and irritancy.

Monomers provided herein are classified as mono-functional monomers or multi-functional monomers, depending upon the number of acrylate and/or methacrylate units in the monomer(s). In some embodiments, the compositions provided include reactive monomers, such as, for example, acrylates, methacrylates, diacrylates, dimethacrylates, triacrylates and/or trimethacrylates. In certain embodiments, acrylates, methacrylates, diacrylates, dimethacrylates, triacrylates and/or trimethacrylates that are incorporated into the present compositions are reactive at the C═C double bond of the (meth-)acrylate moiety of the monomer. In certain embodiments, acrylates, methacrylates, diacrylates, dimethacrylates, triacrylates and/or trimethacrylates that are incorporated into the present compositions are reactive at the C═C double bond of the (meth-)acrylate moiety of the monomer and are not reactive at other sites of the monomer(s).

In certain embodiments, compositions provided herein include a combination of monomers. In certain embodiments, compositions provided herein include at least one monomer that functions as a diluent, which aids in the solubilization of other components of the compositions and/or aids in providing favorable viscosity characteristics to the compositions provided herein. In some embodiments, compositions provided herein include a monomer selected from among isobornyl acrylate, isodecyl acrylate, trimethylolpropane triacrylate (TMPTA), di-trimethylolpropane triacrylate (Di-TMPTA), propoxylated TMPTA (PO6-TMPTA), and combinations thereof. In certain embodiments, compositions provided herein include isobornyl acrylate.

In some embodiments, compositions provided herein include at least one monomer selected from among 2-phenoxyethyl acrylate, isobornyl acrylate, acrylate ester derivatives, methacrylate ester derivatives, tetrahydrofurfuryl acrylate, trimethylolpropane triacrylate, 2-phenoxyethyl acrylate esters, and cross-linking agents, such as, but not limited to, propoxylated glyceryl triacrylate, tripropylene glycol diacrylate, and mixtures thereof. In some embodiments, compositions provided herein include non-aromatic monomers. In some embodiments, compositions provided herein include at least one aromatic monomer.

In some embodiments, the present compositions include a combination of monomers. In some embodiments, compositions provided herein include at least one monomer selected from among 2-phenoxyethyl acrylate, 1,4-butanediol dimethacrylate, tetrahydrofurfuryl acrylate, propoxyl glyceroltriacrylate, methylacrylate, and combinations thereof.

Compositions provided herein include monomers selected from among acrylates, methacrylates, diacrylates, dimethacrylates, triacrylates and trimethacrylates. In some embodiments, compositions provided herein include tetrahydrofurfuryl and at least one additional monomer selected from among acrylates, methacrylates, diacrylates, dimethacrylates, triacrylates and trimethacrylates. In certain embodiments, compositions provided herein include tetrahydrofurfuryl, isobornyl acrylate and at least one additional monomer selected from among acrylates, methacrylates, diacrylates, dimethacrylates, triacrylates and trimethacrylates. In some embodiments, compositions provided include tetrahydrofurfuryl acrylate, isobornyl acrylate, 1,4-butanediol dimethacrylate, and at least one additional monomer selected from among acrylates, methacrylates, diacrylates, dimethacrylates, triacrylates and trimethacrylates. In some embodiments, compositions provided herein include tetrahydrofurfuryl acrylate, isobornyl acrylate, 1,4-butanediol dimethacrylate, 2-phenoxyethyl acrylate, and at least one additional monomer selected from among acrylates, methacrylates, diacrylates, dimethacrylates, triacrylates and trimethacrylates. In some embodiments, compositions provided herein include tetrahydrofurfuryl acrylate, isobornyl acrylate, 1,4-butanediol dimethacrylate, 2-phenoxyethyl acrylate, propoxyl glyceroltriacrylate, and at least one additional monomer selected from among acrylates, methacrylates, diacrylates, dimethacrylates, triacrylates and trimethacrylates.

In certain embodiments, monomer(s) are present in the compositions in an amount ranging from about 2% by weight up to about 90% by weight (wt/wt), such as from about 10% by weight up to about 85% by weight, from about 15% by weight up to about 85% by weight, from about 20% by weight up to about 80% by weight, from about 25% by weight up to about 80% by weight, from about 30% by weight up to about 80% by weight, from about 40% by weight up to about 75% by weight or from about 50% by weight up to about 75% by weight.

In some embodiments, compositions provided herein include a mixture of monomers, wherein each monomer is present in an amount from about 2% by weight up to about 50% by weight, such as from about 5% by weight up to about 40% by weight, from about 5% by weight up to about 35% by weight, from about 5% by weight up to about 30% by weight or from about 10% by weight up to about 25% by weight. Each monomer is present in the compositions provided herein in an amount of about 5%, about 10%, about 20%, about 30%, about 40%, about 50%, about 60%, about 70%, or about 80% by weight (wt/wt).

In certain embodiments, compositions provided herein include tetrahydrofurfuryl acrylate. In certain embodiments, compositions provided herein include tetrahydrofurfuryl acrylate in an amount ranging from about 10% by weight up to about 30% by weight, such as from about 10% by weight up to about 25% by weight or from about 15% by weight up to about 25% by weight. In certain embodiments, compositions provided herein include tetrahydrofurfuryl acrylate in an amount of about 10%, about 15%, about 20%, about 25% or about 30% by weight. In some embodiments, compositions provided herein include tetrahydrofurfuryl in an amount of about 16% by weight up to about 23% by weight.

In some embodiments, compositions provided herein include 2-phenoxyethyl acrylate in an amount ranging from about 4% by weight up to about 40% by weight, such as from about 4% by weight up to about 30% by weight, about 4% by weight up to about 25% by weight, or from about 5% by weight up to about 15% by weight.

In some embodiments, compositions provided herein include 1,4-butanediol dimethacrylate in an amount ranging from about 4% by weight up to about 40% by weight, such as from about 4% by weight up to about 30% by weight, about 4% by weight up to about 25% by weight, or from about 5% by weight up to about 15% by weight. In certain embodiments, compositions provided herein include 1,4-butanediol dimethacrylate in an amount of about 5%, about 10%, about 15% or about 20% by weight.

In certain embodiments, compositions provided herein include isobornyl acrylate in an amount ranging from about 2% by weight up to about 20% by weight, such as from about 5% by weight up to about 18% by weight, about 7% by weight up to about 15% wt/wt, or from about 9% by weight up to about 12% by weight.

In some embodiments, compositions provided herein include propoxylglycerol triacrylate in an amount ranging from about 2% by weight up to about 30% by weight, such as from about 5% by weight up to about 25% by weight, or from about 10% by weight up to about 20% by weight. In some embodiments, compositions provided herein include propoxylglycerol triacrylate in an amount of about 5%, about 8%, about 12%, about 14%, about 16%, about 18%, about 20%, about 22%, about 24%, about 26% or about 28% by weight.

### Cross-Linkable, Silicone Monomers

Compositions provided herein include at least one cross-linkable, silicone acrylate, silicone methacrylate, silicone diacrylate, silicone dimethacrylate, silicone triacrylate and/or silicone trimethacrylate. In certain embodiments, the cross-linkable, silicone acrylate, silicone methacrylate, silicone diacrylate, silicone dimethacrylate, silicone triacrylate and/or silicone trimethacrylate is a surfactant. Cross-linkable, silicone acrylates, silicone methacrylates, silicone diacrylates, silicone dimethacrylates, silicone triacrylates and/or silicone trimethacrylates are employed to impart desirable properties to compositions, such as improved slip, scratch resistance, flow, levelling, release, and defoaming.

Cross-linkable, silicone acrylates, silicone methacrylates, silicone diacrylates, silicone dimethacrylates, silicone triacrylates and/or silicone trimethacrylates are commercially available, such as those manufactured under the name TEGO® Rad by Degussa AG (Essen, Germany) and include TEGO® Rad 2100, 2200, 2250, 2300, 2500, 2600, 2650, and 2700. In some embodiments, compositions provided herein include at least one cross-linkable, silicone acrylate, silicone methacrylate, silicone diacrylate, silicone dimethacrylate, silicone triacrylate and/or silicone trimethacrylate selected from among TEGO® Rad 2100, 2200, 2250, 2300, 2500, 2600, 2650, and 2700. In certain embodiments, compositions provided include at least TEGO® Rad 2100.

In some embodiments, compositions provided herein include at least one cross-linkable, silicone acrylate, silicone methacrylate, silicone diacrylate, silicone dimethacrylate, silicone triacrylate and/or silicone trimethacrylate in an amount ranging from about 0.01% by weight up to about 2.0% by weight, such as about 0.01%, about 0.02%, about 0.03%, about 0.04%, about 0.05%, about 0.06%, about 0.07%, about 0.08%, about 0.09%, about 0.1%, about 0.5%, about 0.8%, about 1.0%, about 1.2%, about 1.4%, about 1.6%, about 1.8, or about 2.0% by weight.

Other surfactants that may be used in the compositions provided herein include, but are not limited to, polymers such as, for example, polystyrene, polypropylene, polyesters, styrene-methacrylic acid type copolymers, styrene-acrylic acid type copolymers, polytetrafluoroethylene, polychlorotrifluoroethylene, polyethylenetetrafluoroethylene type copolymers, polyaspartic acid, polyglutamic acid, and polyglutamic acid-γ-methyl esters; and modifiers such as silane coupling agents and alcohols. Additional surfactants that may be employed in the compositions provided herein include olefins, such as, for example, polyethylene, polypropylene, polybutadiene, and the like; vinyls, such as, for example, polyvinylchloride, polyvinylesters, and polystyrene; acrylic homopolymers and copolymers; phenolics; amino resins; alkyds, epoxys, siloxanes, nylons, polyurethanes, phenoxys, polycarbonates, polysulfones, polyesters (optionally chlorinated), polyethers, acetals, polyimides, and polyoxyethylenes. Further exemplary surfactants include cross-linked as well as non-crosslinked acrylates that are compatible with UV curing compositions, such as crosslinkable silicone acrylate.

In certain embodiments, compositions provided herein include surfactant(s) in an amount ranging from about 0.01% by weight up to about 2.0% by weight, such as about 0.01%, about 0.02%, about 0.03%, about 0.04%, about 0.05%, about 0.06%, about 0.07%, about 0.08%, about 0.09%, about 0.1%, about 0.5%, about 0.8%, about 1.0%, about 1.2%, about 1.4%, about 1.6%, about 1.8, or about 2.0% by weight.

### Metal Salts

In some embodiments, compositions provided herein include at least one metal salt. Metal salts, when incorporated into the compositions provided herein, confer a variety of properties to the compositions. Metal salts, when incorporated into the compositions provided herein, aid in the curing process, aid in the polymerization process, create a thixotropic composition, and/or provided other desirable properties and/or qualities. Compositions provided herein include a low concentration of metal salts. In some embodiments, a catalytic amount of metal salt(s) is/are included into the compositions provided herein, such as, for example, less than about 10% by weight, less than about 5% by weight, less than about 2% by weight, less than about 1% by weight or less than about 0.5% by weight of the total weight of the composition.

In certain embodiments, compositions provided herein include at least one metal salt that aids in the polymerization of the monomers that are present. In some embodiments, compositions provided herein include at least one metal salt that partially polymerizes the composition to produce a thixotropic composition. In certain embodiments, the presence of at least one metal salt in the compositions provided herein produces a thixotropic, non-sticky composition. Absence of the metal salt(s) from the compositions provided herein produces compositions that are less viscous than identical compositions that include at least one metal salt.

In one embodiment, compositions provided herein include at least one metal salt that is ionizable. In another embodiment, compositions provided herein include at least one metal salt with a cation that has a small positive charge. In certain embodiments, compositions provided herein include at least one metal salt with a cation that has a small, localized positive charge. In some embodiments, compositions provided herein include anhydrous metal salts. Metal salts that are included in the compositions provided herein can be obtained from a variety of commercial sources.

In certain embodiments, compositions provided herein include at least one alkali metal salt. In certain embodiments, compositions provided herein include at least one alkaline metal salt. In certain embodiments, compositions provided herein include at least one metal salt selected from among alkali metal salts and alkaline metal salts. In certain embodiments, compositions provided herein include at least one transition metal salt. In certain embodiments, compositions provided herein include at least one metal salt that includes a cation selected from among Li⁺, Na⁺, K⁺, Mg²⁺, Ca²⁺, Al³⁺, Zn²⁺, Mn²⁺, Ti²⁺, Ti³⁺, Ti⁴⁺, Co²⁺, Co³⁺, Sc³⁺ and Ag⁺. In another embodiment, compositions provided herein include at least one metal salt that includes a cation selected from among Li⁺, Na⁺, K⁺, Mg²⁺, and Ca²⁺. In another embodiment, compositions provided herein included at least one metal salt that includes a cation selected from among Li⁺ and Ca²⁺. In some embodiments, compositions provided include at least one metal salt that includes a Li⁺ cation. In another embodiment, compositions provided include a metal salt that includes a Ca²⁺ cation.

In one embodiment, the compositions provided herein include at least one metal salt that includes an anion selected from among F⁻, Cr, Br⁻, I⁻, CO₃²⁻, ClO₄⁻ and NO₃. In another embodiment, compositions provided herein include at least one metal salt that includes an anion selected from among Cl⁻, Br⁻, I⁻, and CO₃². In yet another embodiment, the compositions provided herein include at least one metal salt that includes an anion selected from among Cl⁻, Br⁻, and I⁻. In still another embodiment, the compositions provided herein include at least one metal salt that includes a Cl⁻ anion.

In certain embodiments, composition provided herein include at least one metal salt selected from among LiCl, NaCl, KCl, MgCl₂, CaCl₂, AgCl, ZnCl₂, LiBr, LiI, NaBr, NaI, KBr, KI, MgBr₂, MgI₂, CaBr₂, CaI₂, AgBr, AgI, ZnBr₂, and ZnI₂. In one embodiment, the compositions provided herein include at least one metal salt selected from among LiCl and CaCl₂. In some embodiments, the compositions provided herein include LiCl. In other embodiments, the compositions provided herein include CaCl₂. In some embodiments, the composition provided herein include one metal salt. In other embodiments, the compositions provided herein include at least one metal salt. In other embodiments, the compositions provided herein include at least two metal salts.

The compositions provided herein include at least one metal salt at a concentration of about 0.1% by weight up to about 5% by weight, such as about 0.1% by weight up to about 4% by weight, about 0.1% by weight up to about 3% by weight, about 0.1% by weight up to about 2% by weight, about 0.1% by weight up to about 1% by weight, about 0.1% by Weight up to about 0.8% by weight, about 0.1% by weight up to about 0.6% by weight, or about 0.2% by weight up to about 0.6% by weight. In some embodiments, compositions provided herein include at least one metal salt at a concentration of about 0.1%, about 0.2%, about 0.3%, about 0.4%, about 0.5%, about 0.6%, about 0.7%, about 0.8%, about 1%, about 1.5%, about 2%, about 2.5%, about 3%, about 3.5%, about 4%, about 4.5%, or about 5% by weight.

### Pigments and Pigment Dispersions

Compositions provided herein may optionally include at least one pigment or pigment dispersion. Pigments, are insoluble white, black, or colored material, typically suspended in a vehicle for use in a paint or ink, and may also include effect pigments such as micas, metallic pigments such as aluminum, and opalescent pigments. Pigments are used in coatings to provide decorative and/or protective functions. However, due to their insolubility, pigments may be a possible contributing factor to a variety of problems in liquid coatings and/or dry paint films. Examples of some film defects thought to be attributable to pigments include: undesirable gloss due to aggregates, blooming, pigment fading, pigment flocculation and/or settlement, separation of pigment mixtures, brittleness, moisture susceptibility, fungal growth susceptibility, and/or thermal instability.

Various organic pigments can be used in the compositions described herein, including, but not limited to, carbon black, azo-pigment, phthalocyanine pigment, thioindigo pigment, anthraquinone pigment, flavanthrone pigment, indanthrene pigment, anthrapyridine pigment, pyranthrone pigment, perylene pigment, perynone pigment and quinacridone pigment.

Various inorganic pigments can be used in the compositions described herein, for example, but not limited to, titanium dioxide, aluminum oxide, zinc oxide, zirconium oxide, iron oxides: red oxide, yellow oxide and black oxide, Ultramarine blue, Prussian blue, chromium oxide and chromium hydroxide, barium sulfate, tin oxide, calcium, titanium dioxide (rutile and anatase titanium), sulfate, talc, mica, silicas, dolomite, zinc sulfide, antimony oxide, zirconium dioxide, silicon dioxide, cadmium sulfide, cadmium selenide, lead chromate, zinc chromate, nickel titanate, clays such as kaolin clay, muscovite and sericite.

In further or alternative embodiments, compositions provided herein include polymerizable pigment dispersions that include at least one pigment attached to an activated resin; wherein the activated resin is selected from a group consisting of acrylate resins, methacrylate resins, and vinyl resins, and the pigment is selected from a group consisting of carbon black, rutile titanium dioxide, organic red pigment, phthalo blue pigment, red oxide pigment, isoindoline yellow pigment, phthalo green pigment, quinacridone violet, carbazole violet, masstone black, light lemon yellow oxide, light organic yellow, transparent yellow oxide, diarylide orange, quinacridone red, organic scarlet, light organic red, and deep organic red. These polymerizable pigment dispersions are distinguishable from other pigment dispersions which disperse insoluble pigment particles in some type of resin and entrap the pigment particles within a polymerized matrix. The pigment dispersions used in the compositions and methods described herein have pigments treated such that they are attached to acrylic resins; consequently the pigment dispersion is polymerizable upon exposure to UV irradiation.

An “ideal” dispersion consists of a homogeneous suspension of primary particles. However, inorganic pigments are often incompatible with the resin in which they are incorporated, and this generally results in the failure of the pigment to uniformly disperse. Furthermore, a milling step may be required as dry pigments comprise a mixture of primary particles, aggregates, and agglomerates which must be wetted and de-aggregated before the production of a stable, pigment dispersion is obtained. The level of dispersion in a particular pigment-containing coating composition affects the application properties of the composition as well as the optical properties of the cured film. Improvements in dispersion result in improvements in gloss, color strength, brightness, and gloss retention.

Compositions provided herein optionally include at least one pigment or pigment dispersion in an amount ranging from about 1% by weight up to about 15% by weight, such as about 3% by weight up to about 10% by weight, or about 5% by weight up to about 9% by weight.

### Additional Agents

Compositions herein may optionally include adhesion promoters, corrosion inhibitors, curing boosters, and/or fillers to obtain desirable chemical and mechanical properties.

Compositions provided herein may further include additional fillers that are not necessarily nano-fillers, such as amorphous silicon dioxide prepared with polyethylene wax, synthetic amorphous silica with organic surface treatment, IRGANOX®, untreated amorphous silicon dioxide, alkyl quaternary bentonite, colloidal silica, acrylated colloidal silica, alumina, zirconia, zinc oxide, niobia, titania aluminum nitride, silver oxide, cerium oxides, and combinations thereof. Further, the average size of the filler particles is less than about 10 micrometers, or less than about 5 micrometers, or even less than about 1 micrometer.

### Methods of Using Compositions

Compositions described herein may be applied to any non-metal substrate, which would benefit from a coating, or partial coating, of a cured composition provided herein. Non-metal substrates coated with at least one composition provided herein can then be exposed to actinic radiation in order to cure the coated composition and provide a cured, coated non-metal product. Cured coatings of the compositions provided herein provide a benefit to the non-metal object, such as for example:
(a) resistance to water or wetting;
(b) retention of structural strength;
(c) retention of color, brightness, print;
(d) resistance to scratch;
(e) gloss; and/or
(f) resistance to mold, algae, mildew, bacterial, and/or fungal growth.

Compositions provided herein are suitable for coating thermally sensitive objects. Compositions provided herein can be cured in cold temperatures. In some embodiments, compositions provided herein can be applied to non-metal objects outside in winter time and cured with sunlight without the need for curing ovens and the like. In some embodiments, compositions provided herein can be applied to the outer surface of buildings and cured with sunlight even when the outside temperature is below 0° C.

Non-metal substrates that include the present compositions can be exposed to a source of actinic radiation, such as ultraviolet light, to effect curing. Thus, one aspect of the methods described herein is drawn to methods of manufacturing non-metal products, the method including (a) providing a non-metal substrate; (b) applying a composition to the non-metal substrate to produce a non-metal product; and (c) curing the non-metal product, wherein the composition is disclosed herein.

### Architectural Applications

Compositions provided herein find use in a variety of architectural applications. A variety of non-metal substrates used in architecture may benefit from a coating of at least one composition provided herein. Non-metal substrates used in architecture include, but are not limited to, brick, cement, stucco, drywall, ceramic, glass, polycarbonate, plastic and fiber substrates, such as, for example, wood and paper substrates, and non-wood based cellulose products. Compositions provided herein are thixotropic and establish a substantially stable form after shear stress has been applied to the composition; in other words, the compositions can be forcible applied, rolled-on, wiped on, spread on, and/or brushed onto the surface of non-metal substrates, after application, the compositions resist flow and establish a substantially stable form. In certain embodiments, compositions with a lower viscosity may be desired. In embodiments where a lower viscosity is desired, compositions are prepared as disclosed herein without the addition of any metal salt. Compositions disclosed herein that have a lower viscosity may be desirable for coatings that require spraying, soaking, curtain coating, blade coating or for non-metal objects that are not structural durable when a viscous composition provided herein is forcibly applied, see for example, U.S. patent application Ser. No. 11/234,672, paragraphs [0094] through [00106], incorporated herein by reference.

In some embodiments, compositions provided herein are applied to non-metal objects and then cured with sunlight in a matter of minutes up to a few hours. In some embodiments, compositions provided herein can be applied to non-metal objects in cold temperatures, such as, for example, in winter-time, and then cured with sunlight without the need for thermal ovens or heat lamps.

In some embodiments, compositions provided herein are applied to the outside of a building, such as, for example, a house, garage, church, store and/or factory. Compositions provided herein are thixotropic, and thus do not substantially flow once applied. Compositions provided herein are viscous and thus provide a thicker, textured, structurally defined coating, if desired. The thickness, texture and/or structural definition of a coat can be controlled during the coating process.

Compositions provided herein are 100% solids, UV curable compositions. There is no need to drive off organic solvents during the curing process, and thus the compositions provided herein are environmentally friendly and can be cured at any temperature.

Compositions provided herein have desirable properties, such as, but not limited to, viscosity. In some embodiments, thixotropic, UV curable compositions provided herein find use in filling in cracks, holes or any other void in a non-metal object. Thixotropic, UV curable compositions provided herein are viscous and substantially remain where they are applied. In other embodiments, thixotropic, UV curable compositions provided herein can be applied as a coat on a non-metal object and then contoured to provide a textured and/or structurally-defined surface. The textured surface is then exposed to actinic radiation, such as, for example, sunlight to provide a cured, textured coating.

In some embodiments, a clear, thixotropic, UV curable composition provided herein is applied to glass and polycarbonate substrates. In some embodiments, compositions provided herein are used to fill in voids in glass or polycarbonate substrates, such as for example, cracks, scratches, and/or holes. The applied UV curable, thixotropic compositions do not experience a reduction in volume during the curing process because there is no need to evaporate organic solvents in order to effect curing. Thus, UV curable, thixotropic compositions provided herein can be manipulated during the coating/application stage. Upon curing, the cured compositions are rigid and thus are difficult to mold into desired shapes/textures.

In some embodiments, a non-thixotropic, UV curable composition is desirable. Non-thixotropic UV curable compositions are prepared as disclosed herein, but omitting the addition of any metal salt to the compositions. Non-thixotropic, UV curable compositions are less viscous and are suitable for application to fiber substrates, see for example, U.S. patent application Ser. No. 11/234,672, paragraphs [0089] through [0093], incorporated by reference.

### Compositions as Sealants

In some embodiments, compositions provided herein are applied to non-metal substrates in order to provide a water-repellant coat. Water repellant coats are desirable for some non-metal objects because the cured coating offers at least one of the following benefits to the non-metal product:
(a) resistance to water or wetting;
(b) retention of structural strength;
(c) retention of color, brightness, print;
(d) resistance to scratch;
(e) gloss; and/or
(f) resistance to mold, algae, mildew, bacterial, and/or fungal growth.

In some embodiments, compositions provided herein are applied on top of a pre-existing coating. In other embodiments, compositions provided herein are applied to a non-metal object in multiple coats.

In some embodiments, compositions provided herein are applied to computer circuitry/components and/or electronic circuitry/components. Computer circuitry/components and/or electronic circuitry/components that include a cured coating of a composition provided herein provide, at least, resistance to water and/or wetting, and retention of ink on the circuitry/components. Compositions that contain organic solvents may not be compatible with the materials that computer circuitry/components are made from.

### Other Applications

In one embodiment, provided herein, is an article of manufacture that comprises:
(a) a fiber object; and
(b) a coating of a cured composition provided herein.

In one embodiment, provided herein, is a paper product and/or a cellulose-based product that comprises:
(a) a paper substrate and/or a cellulose-based substrate; and
(b) a composition provided herein.

In some embodiments, the composition provided herein is applied to a paper substrate and/or a cellulose-based substrate, and is impregnated into the surface of the paper substrate and/or the cellulose-based substrate. In certain embodiments, the paper product, once it has been coated/impregnated with a composition provided herein is treated with an additional metal salt that is impregnated into the applied composition, wherein the additional metal salt lowers the freezing temperature of water. In some embodiments, the composition is cured in and/or on to the paper substrate. In other embodiments, the paper product and/or the cellulose-based product, after exposure to water, exhibits at least one of the following characteristics selected from the group consisting of:
(a) retention of structural strength;
(b) retention of ink or pencil writing;
(c) retention of print;
(d) retention of brightness; and
(e) release of the additional metal salt, which lowers the freezing temperature of water, from the paper product.

In other embodiments, the paper product and/or the cellulose-based product, after exposure to water, exhibits at least two of the aforementioned characteristics. In some embodiments, the paper product and/or the cellulose-based product, after exposure to water, exhibits at least three of the aforementioned characteristics.

In another embodiment, provided herein is a process of making paper products, comprising:
(a) providing a paper substrate;
(b) applying a composition provided herein to the paper substrate;
(c) optionally adding a metal salt to the applied composition of (b), wherein the metal salt lowers the freezing temperature of water; and
(d) curing the paper substrate that comprises the composition.

In some embodiments, the composition is partially impregnated into the paper substrate. In some embodiments, provided herein is a paper product produced by the above process.

### Flexible Surfaces Formed from Sheeting Material Treated with UV Curable Compositions are Useful for Melting Ice, Snow, and for Other Purposes

In some embodiments, the UV curable compositions can be impregnated on a material to form an impregnated flexible surface (also referred herein as a “mat”). The compositions can also be coated on one or both sides of a material to form an impregnated flexible surface. The material to be impregnated (i.e., the “sheeting material”) can be formed from any suitable material, and can be flexible or rigid. The sheeting material can be any shape or size; the sheeting material can be transparent, translucent or opaque; the sheeting material can be colorless or colored. Exemplary sheeting materials include but are not limited to polycarbonate, plastic, paper, a fiber or fibrous substrate, cloth, wool, plant-based material, animal-based material, man-made material, and the like. In some embodiments, the sheeting material is prepared from recycled materials. In some embodiments, the sheeting material is recycled paper, such as, for example, recycled newspaper.

The treated sheeting material can then be formed into various useful products. Additional coatings can be added to one or both sides of the sheeting material, depending on the product to be formed. For example, the UV curable waterproofing formulation can be placed on one side of the sheet, while a salt mixture is placed on the other side of the sheet. In other embodiments, the sheet can be impregnated with the UV curable composition, and other coating materials are added on top of one or both sides of the impregnated sheet.

Paper products that contain a cured composition disclosed herein with an additional metal salt, which lowers the freezing temperature of water, impregnated into the cured composition can be used as, for example, snow and/or ice melting paper mats. Contact of the snow and/or ice melting paper mats to snow and/or ice will lead to release of the additional metal salt, thus lowering the freezing temperature of water. The structural integrity of the paper mat is not affected by the presence of snow, ice and/or water due to the fact that cured compositions disclosed herein exhibit resistance to water and or wetting. Snow and/or ice melting mats are desirable because it allows the user a snow and/or ice free surface to stand, walk, and or run on. Snow and/or ice melting mats allow the user to stand, walk and/or run on the snow- and/or ice-free surface of the mat, while the other side of the mat is in contact with snow and/or ice and releases the metal salt onto/into the snow/ice, thus lowering the freezing temperature of water, and therefore melts the snow and/or ice.

Salts commonly used to melt snow and/or ice, and contemplated for use in the snow and/or ice melting mats, include, but are not limited to, halite (rock salt), CaCl₂, MgCl₂, NaCl, KCl, ammonium sulfate, calcium magnesium acetate, potassium acetate, urea, and the like. The salts can be present at any desired concentration. For example, a salt can be present at from less than about 1%, or about 5%, 10%, 20%, 40%, 60%, 80%, 90%, 95%, or greater. The salt can be a single type of salt, or can be a mixture of salts.

The salt used in a mat coating can also be an organic salt, a mixture of organic salts, or a mixture of organic salts and metal salts. In some embodiments, organic salts are desirable because they can have a decreased corrosion effect on metal objects. Accordingly, when a metal object is to be de-iced, a mat containing an organic salt is one embodiment. Exemplary organic salts include, for example, carboxylate salts, formate, acetate, propionate, pyruvate, oxalate, malate, tartrate, isocitrate, succinate, glutarate, caproate, benzoate, lactate, citrate, and the like. Organic salts may be used in place of inorganic salts in situations where they result in to less harm to the surrounding environment.

Mat coatings can also contain powdered silica gel at various concentrations. For example, a mat coating can contain from about 0, 5, 10, 20, 30, 40, 50, 60, 70, 80, 90, 98% or more silica gel. The silica gel can be powdered to any suitable size. The silica gel is capable of absorbing moisture.

A mat can also have at least one coating that is or contains an adhesive. For example, to prepare a mat having at least one layer of salt, the salt can be mixed with an adhesive to increase bonding of the salt to the mat substrate. In some embodiments, the adhesive is the UV curable compositions described herein, however, additional adhesives can be employed, including acrylic adhesives, cyanoacrylate adhesives, natural adhesives, synthetic adhesives, epoxy adhesives, hot melt adhesives, polyurethane adhesives, silicone rubber adhesives, polyvinyl acetate adhesives, and the like.

The mats can be of any desired thickness. Mat thickness can be, for example, from less than about 0.1 mm, about 0.5 mm, about 1 mm, about 3 mm, about 5 mm, about 1 cm, about 2 cm, or greater in thickness. The mat thickness can vary depending on the type and thickness of the fiber substrate, the type and thickness of the coating, and other factors.

The fiber substrate used for the base of the mat can be prepared from recycled materials. The recycled material can be obtained in a sheet form (such as newsprint), or can be in another form to be processed to layers of a desired thickness before coating.

The mat can be made to have any desired amount of flexibility. The type and thickness of fiber substrate, as well as the type and thickness of the coating materials can affect the flexibility. In some embodiments, the mat is relatively flexible in order to allow it to be placed or moved easily during use. The flexibility also allows the mat to be easily rolled up for compact storage when not in use.

### Snow Melting Mat

In some embodiments, a fiber substrate layer can be treated with compositions described herein to form a mat that can be used to melt snow or ice. In some embodiments, the fiber substrate is paper, including recycled paper, such as newsprint. The mat can be placed on various items, such as sidewalks, entryways, driveways, patios, equipment, and roofs, to melt accumulated snow or ice and to prevent further snow or ice buildup. The mat can be treated with a coating containing a salt or mixtures of salts, adhesives, silica gels, or other additives as described below.

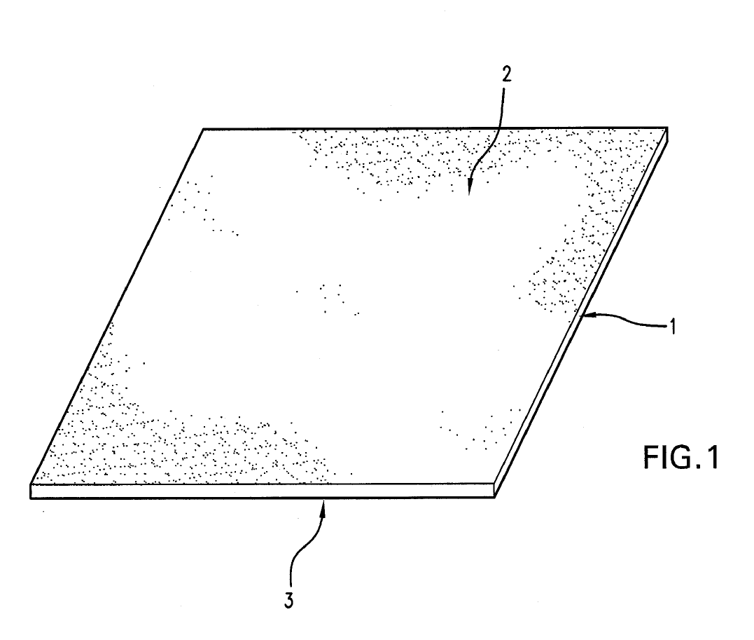

A drawing of an exemplary snow melting mat is shown in FIG. 1. In one embodiment, a fiber substrate, e.g., paper (1), is impregnated with UV curable waterproofing formulation with nanoparticles as described herein. The paper can be coated from either side, or can be dipped into the coating. The top (2) and bottom (3) sides can be coated with salt or salt mixtures.

The coating for the bottom of the snow melting mat can contain salt or a mixture of salts. For example, a composition of 80% NaCl, and 20% Na Acetate can be mixed with the UV curable compositions described herein, however, additional adhesives can be employed, including acrylic adhesives, cyanoacrylate adhesives, natural adhesives, synthetic adhesives, epoxy adhesives, hot melt adhesives, polyurethane adhesives, silicone rubber adhesives, polyvinyl acetate adhesives, and the like. Examples 6, 7, and 8 describe suitable methods of making and using a snow melting mat.

The coating for the top of the snow melting mat can contain salt or a mixture of salts. The coating for the top side of the snow melting mat can also contain silica gel to help absorb moisture, if desired. The silica gel can be powdered to any suitable size, and can be present in the coating from about 0, 5, 10, 20, 30, 40, 50, 60, 70, 80, 90, 98% or more silica gel. In an embodiment, the top coating contains 60% to 90% silica gel, with the remainder being sodium acetate. In another embodiment, the top coating contains about 50% silica gel, 25% sodium citrate, and 25% CaCl₂. In one embodiment, the top coating contains about 75% NaCl and 25% silica gel, which is attached to a 100% recycled paper substrate using a UV curable urethane adhesive. Sand or pumice may be added to the coating for the top of the snow melting mat for increased traction. In one embodiment, the top coating contains about 75% NaCl and 25% pumice, which is attached to a 100% recycled paper substrate using a UV curable urethane adhesive.

Exemplary salts that can be used for the snow melting mat include but are not limited to inorganic salts such as NaCl, CaCl₂, MgCl₂, organic salts such as sodium or potassium salts of carboxylates, formate, acetate, propionate, pyruvate, oxalate, malate, tartrate, isocitrate, succinate, glutarate, caproate, benzoate, lactate, citrate, and the like.

The salts and/or silica gel can be mixed with any suitable adhesive to form the coating. Examples of suitable adhesives include but are not limited to the UV curable compositions described herein, however, additional adhesives can be employed, including acrylic adhesives, cyanoacrylate adhesives, natural adhesives, synthetic adhesives, epoxy adhesives, hot melt adhesives, polyurethane adhesives, silicone rubber adhesives, polyvinyl acetate adhesives, and the like.

The snow melting mat can be of any desired thickness and flexibility. Snow melt mat thickness can be, for example, from less than about 0.1 mm, about 0.5 mm, about 1 mm, about 3 mm, about 5 mm, about 1 cm, about 2 cm, or greater in thickness. The mat thickness can vary depending on the type and thickness of the fiber substrate, the type and thickness of the coating, and other factors.

### Freezer Defrosting Mat

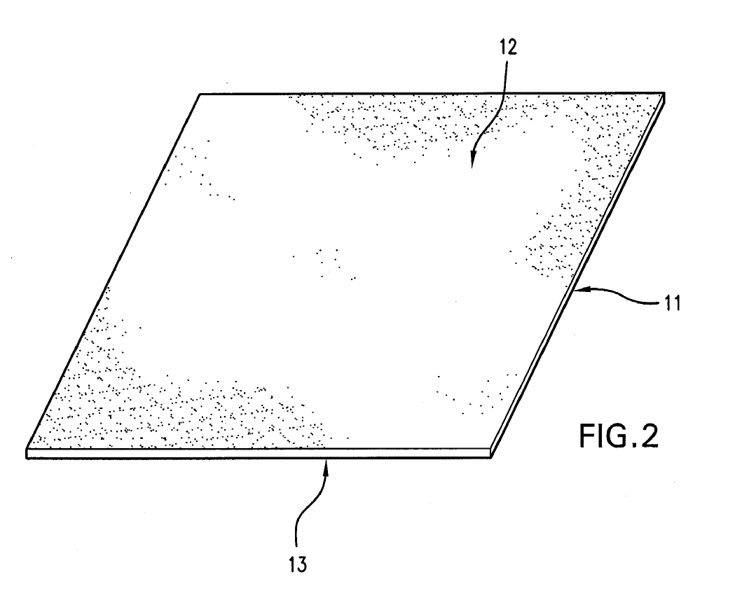

In some embodiments, the compositions can be used to prepare a mat for defrosting ice buildup in a freezer. A drawing of an embodiment of a freezer defrosting mat is shown in FIG. 2. A fiber substrate (11), is coated with compositions described herein. In one embodiment, the fiber substrate is made from recycled paper, such as recycled newspaper.

In one embodiment, the top of the freezer defrosting mat (12) is impregnated with a composition having UV curable waterproofing formula with nanoparticles (nanofiller) as described herein. The bottom of the mat (13) can contain a salt or mixture of salts, mixed with an adhesive such as UV curable urethane. The mat can be flexible, so that it can be moved around the freezer as needed. Example 9 describes one possible method of making and using a freezer defrosting mat.

In some embodiments, the bottom of the freezer defrosting mat can have salt or salt mixtures attached to the fiber substrate using an adhesive. In one embodiment, the salt is an organic salt so as to decrease corrosion effects on the freezer shelves. Exemplary salts that can be used include but are not limited to inorganic salts such as NaCl, CaCl₂, MgCl₂, organic salts such as sodium or potassium salts of carboxylates, formate, acetate, propionate, pyruvate, oxalate, malate, tartrate, isocitrate, succinate, glutarate, caproate, benzoate, lactate, citrate, and the like.

The salts can be mixed with any suitable adhesive. Examples of suitable adhesives include but are not limited to the UV curable compositions described herein, however, additional adhesives can be employed, including acrylic adhesives, cyanoacrylate adhesives, natural adhesives, synthetic adhesives, epoxy adhesives, hot melt adhesives, polyurethane adhesives, silicone rubber adhesives, polyvinyl acetate adhesives, and the like.

The freezer defrosting mat can be of any desired thickness and flexibility. The mat thickness can be, for example, from less than about 0.1 mm, about 0.5 mm, about 1 mm, about 3 mm, about 5 mm, about 1 cm, about 2 cm, or greater in thickness. The freezer defrosting mat thickness can vary depending on the type and thickness of the fiber substrate, the type and thickness of the coating, and other factors.

The freezer defrosting mat can be of any desired size. Mats can have a length and or width, for example, of less than about 6 inches, about 6 inches, or about 1, 2, 3, 4, 5, 7, 10 feet, or greater. In some embodiments, the mats can also be prepared in the form of a long roll, to be cut to any desired size by the user.

The freezer defrosting mat can be reusable, or can be disposable. In some embodiments, the mat is designed for single-use defrosting of a freezer.

In one embodiment, the freezer defrosting mat contains an organic salt which is less corrosive, and the adhesive is a UV curable composition described herein, which results in a more flexible mat. Any suitable method for applying the coatings and for curing the freezer defrosting mat can be used.

### Shelf Paper

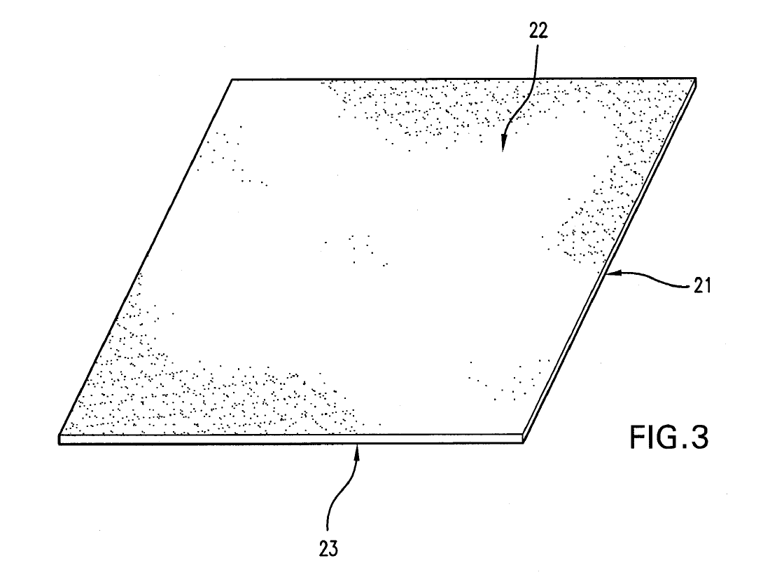

In addition to use of the mats to thaw snow or ice, the fiber substrates can also be coated to prepare a sheeting material that can be useful for specialized shelf paper. In one embodiment, the shelf paper is insect resistant or insect repellant. This type of shelf paper is particularly useful for storage of foodstuffs or long term storage of paper items. A drawing of an embodiment of an insect-repellant shelf paper is shown in FIG. 3. In one embodiment, the shelf paper (21) has a waterproof top side (22) which has been impregnated with a UV curable waterproofing composition described herein, while the bottom side (23) is coated with silica gel and insect repellant agents such as borax and boric acid, or other agents, attached to the fiber substrate with an adhesive such as UV curable urethane.

In some embodiments, the bottom side of the shelf paper contains silica gel. Any suitable amount of silica gel, such as, for example 1%, 5%, 10%, 15%, 20%, 30%, 40%, 50%, 60%, 70%, 80%, 90%, 95% or greater can be used. The silica gel can be powdered.

Insect deterrent or insecticidal compounds can be added to the shelf paper. Boric acid, for example, is a naturally occurring material with insecticidal activity against cockroaches, ants, termites, and other insects. In some embodiments, the bottom side of the shelf paper contains boric acid. The boric acid can be present, for example, at a concentration of from about 1%, 5%, 10%, 15%, 20%, 30%, 40%, 50%, 60%, 70%, 80%, 90%, 95% or greater. Other insect repellant compounds can also be added.

The bottom side of the shelf paper can also contain borax. The borax can be present, for example, at a concentration of from about 1%, 5%, 10%, 15%, 20%, 30%, 40%, 50%, 60%, 70%, 80%, 90%, 95% or greater.

In one embodiment, the mixture is combined with an adhesive to attach the composition to the bottom of the shelf paper. Examples of suitable adhesives include but are not limited to the UV curable compositions described herein, however, additional adhesives can be employed, including acrylic adhesives, cyanoacrylate adhesives, natural adhesives, synthetic adhesives, epoxy adhesives, hot melt adhesives, polyurethane adhesives, silicone rubber adhesives, polyvinyl acetate adhesives, and the like.

The shelf paper mat can be of any desired size. Mats can have a length and or width, for example, of less than about 6 inches, about 6 inches, or about 1, 2, 3, 4, 5, 7, 10 feet, or greater. In some embodiments, the shelf paper mats can also be prepared in the form of a long roll, to be cut to any desired size by the user. The shelf paper mat can be designed to be reusable, or can be disposable.

The fiber substrate used for the base of the shelf paper mat can be prepared from natural, synthetic, or recycled materials. In one embodiment, the fiber substrate for the shelf paper is derived from recycled materials, such as recycled paper. The recycled material can be obtained in a sheet form (such as newsprint), or can be in another form to be processed to layers of a desired thickness before coating.

Any suitable method for applying the coatings and for curing the shelf paper mat can be used. Example 11 describes one suitable method of making the shelf paper, as well as a method of testing the paper to confirm anti-insect activity.

### Window Cover

In some embodiments, the compositions can be used to prepare a mat or cover that can be placed on a window (including the windshield of a vehicle) to protect it from accumulating snow or ice. The thickness and flexibility of the cover can be varied; the window cover can be transparent, translucent or opaque. In some embodiments, the bottom of the cover is impregnated with UV curable waterproofing formulation with nanoparticles (nanofiller) as described herein.

In some embodiments, the top side of the window cover can contain silica, which can be powdered. Any suitable amount of silica gel, such as, for example 1%, 5%, 10%, 15%, 20%, 30%, 40%, 50%, 60%, 70%, 80%, 90%, 95% or greater can be used. This can be attached using an adhesive.

In some embodiments, the top of the window cover mat can have salt or salt mixtures attached to the fiber substrate using an adhesive. Exemplary salts that can be used include but are not limited to inorganic salts such as NaCl, CaCl₂, MgCl₂, organic salts such as sodium or potassium salts of carboxylates, formate, acetate, propionate, pyruvate, oxalate, malate, tartrate, isocitrate, succinate, glutarate, caproate, benzoate, lactate, citrate, and the like.

The salts and/or silica gel can be mixed with any suitable adhesive. Examples of suitable adhesives include but are not limited to the UV curable compositions described herein, however, additional adhesives can be employed, including acrylic adhesives, cyanoacrylate adhesives, natural adhesives, synthetic adhesives, epoxy adhesives, hot melt adhesives, polyurethane adhesives, silicone rubber adhesives, polyvinyl acetate adhesives, and the like. Any suitable method for applying the coatings and for curing the window cover material can be used.

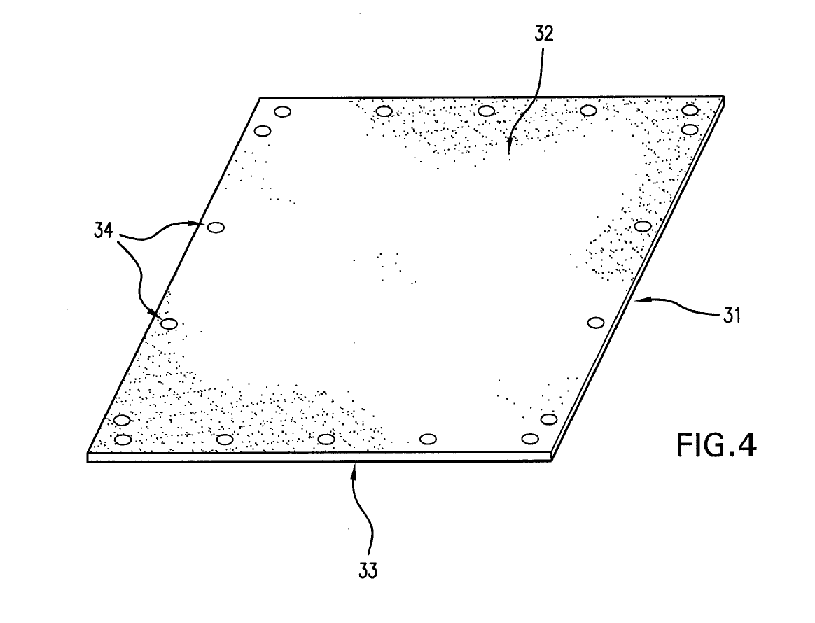

A drawing of an embodiment of a window cover is shown in FIG. 4. In one embodiment, the bottom (33) of the substrate (31) is impregnated with UV curable waterproofing formulation with nanoparticles (nanofiller) as described herein. The top (32) is treated with a mixture of from about 0% to about 25% powdered silica gel and from about 75% to about 100% of a salt or a salt mixture, attached with a suitable adhesive, such as UV curable urethane.

In some embodiments, a means to attach the cover to the windshield or to the body of the car is added to the cover. One such attachment means is by use of several magnets (34) placed near the edges of the cover. The magnets are fastened to the body of the car. This method allows the cover to stay in place even during high winds or storms. The magnets can be of any suitable shape and size, including segments that are rounds, square, flat, oval, or magnetic strips. Other attachment means, such as ties, clips, or weights, can be used. Example 10 describes one suitable method of making and using a windshield cover mat.

The fiber substrate used for the base of the window cover mat can be prepared from recycled materials. The recycled material can be obtained in a sheet form (such as newsprint), or can be in another form to be processed to layers of a desired thickness before coating.

The mat can be made to have any desired amount of flexibility. The type and thickness of fiber substrate, as well as the type and thickness of the coating materials can affect the flexibility. In some embodiments, the mat is relatively flexible in order to allow it to be placed or moved easily during use. The flexibility also allows the mat to be easily rolled up for compact storage when not in use.

The window cover mat can be of any desired thickness and flexibility. The mat thickness can be, for example, from less than about 0.1 mm, about 0.5 mm, about 1 mm, about 3 mm, about 5 mm, about 1 cm, about 2 cm, or greater in thickness. The mat thickness can vary depending on the type and thickness of the fiber substrate, the type and thickness of the coating, and other factors.

The window cover mat can be of any desired size. Mats can have a length and or width, for example, of less than about 6 inches, about 6 inches, or about 1, 2, 3, 4, 5, 7, 10 feet, or greater. In some embodiments, the mats can also be prepared in the form of a long roll, to be cut to any desired size by the user. In one embodiment, the mat is pre-cut to fit the front and back windows of typical vehicles.

The window cover mat can be reusable, or can be disposable. In some embodiments, the mat is designed for single-use. In other embodiments, the window cover is designed for multiple use.

### Compositions as Adhesives

Common adhesives in use typically contain harmful chemicals, such as, for example, volatile organic solvents. In certain embodiments, compositions provided herein are useful as adhesives. Compositions provided herein do not contain toxic, volatile organic solvents, which need to be evaporated or driven off after application to substrates. In some embodiments, compositions provided herein are applied to non-metal substrates, such as, for example, UV-transparent substrates, such as, for example, glass and polycarbonate substrates. In some embodiments, compositions provided herein are applied to non-metal substrates, such as, for example, UV-transparent substrates, such as, for example, glass and polycarbonate substrates, and are impregnated into the surface of the non-metal substrate. In certain embodiments, clear, pigment free compositions are used as an adhesive. In some embodiments, compositions provided herein, with or without metal salt(s) are used as an adhesive for non-metal objects.

In certain embodiments, compositions provided herein are used as an adhesive for UV-transparent non-metal objects. In some embodiments, the UV-transparent non-metal object is a glass object. In other embodiments, the UV-transparent non-metal object is a polycarbonate object. In certain embodiments, the use of a composition provided herein as an adhesive for UV-transparent non-metal objects includes:
(i) applying a composition provided herein to the UV-transparent non-metal object;
(ii) contacting the applied composition on the UV-transparent non-metal object of (i) with a second non-metal object; and
(iii) curing the composition with actinic radiation.

In some embodiments, the applied composition is impregnated, at least in part, into the surface of the non-metal, UV transparent substrate. In other embodiments, the cured composition is impregnated, at least in part, into the surface of the non-metal, UV transparent substrate.

### Applying Compositions to Non-Metal Substrates

Compositions provided herein can be applied to non-metal substrates in order to produce non-metal products. The non-metal products can be exposed to actinic radiation, such as, for example, sunlight, in order to cure the coated compositions. In certain embodiments, compositions provided herein are applied to non-metal substrates by means of wiping, brushing, rolling, dipping, smearing or a combination thereof. Any other means for applying thixotropic, UV curable, viscous compositions provided herein are contemplated. In an embodiment, the composition is forcibly applied onto the non-metal substrates. In some embodiments, compositions provided herein do not include a metal salt and are not thixotropic and have a reduced apparent viscosity compared to identical compositions that include at least one metal salt. Methods of applying metal salt-free compositions are disclosed in U.S. patent application Ser. No. 11/234,672, paragraphs [0094] through [00106], incorporated by reference.

Non-metal substrates may be coated with varying amounts of the present compositions. For example, non-metal substrates may be partially coated or wholly coated with the present compositions. In further or alternative embodiments, the surfaces of the non-metal substrate become partially covered, or become fully covered by the uncured coating.

In further or alternative embodiments, the compositions provided herein are applied in a single application, or in multiple applications. In further or alternative embodiments, multiple compositions are applied to the non-metal substrate. In further or alternative embodiments, multiple compositions are applied simultaneously or sequentially to the non-metal substrates.

In further or alternative embodiments, compositions provided herein are applied to non-metal substrates at ambient temperature, or at temperatures higher or lower than ambient temperature. In some embodiments, compositions provided herein are applied to non-metal substrates, such as for example, building and/or architectural non-metal substrates in winter weather and cured by sunlight.

In one aspect are assemblages for manufacturing non-metal products that are compatible with compositions provided herein, wherein the assemblages include means for applying the present composition(s) to non-metal substrates. In an embodiment, assemblages include means for spraying, soaking, wiping, curtain coating, dipping, rolling, brushing, or throwing the present composition(s) onto the surface of a non-metal substrate. However, for less viscous compositions, forcible application or centrifugal application by way of a lens is the most efficacious methods of application, and can be accomplished by delivering a measuring dosed of the composition via a rotating lens. While not wishing to be bound by a particular theory, it is believed that application of the lower-viscosity composition by a rotating lens facilitates an impregnation of the composition into the non-metal substrate, such as fiber substrates, and that impregnation of the composition imparts desirable characteristics: (a) retention of writability of pen and/or ink; (b) retention of print; (c) resistance to water or wetting; and/or (c) retention of brightness.

### Curing UV-Curable Compositions

In some embodiments, described herein are methods, processes, devices and assemblages for curing non-metal substrates that include compositions provided herein. Curing can be achieved by exposure to actinic radiation. The actinic radiation is selected from the group consisting of visible radiation, near visible radiation, ultra-violet (UV) radiation, and combinations thereof. Further, the UV radiation is selected from the group consisting of UV-A radiation, UV-B radiation, UV-C radiation, UV-D radiation, or combinations thereof. In some embodiments, the actinic radiation is sunlight (particularly for uses in which the compositions are applications outdoors, including glass repair, coating/texturizing architectural components, and adhesion).

Generally, UV-curable compositions are prepared using a single or mixture of photo-initiators sufficient to encompass all necessary frequencies of light. These are used to work with the lights or light pairs, arranged to ensure complete cure of an object. Polymerization, in particular acrylate double bond conversion and induction period, can be affected by the choice of monomers, photo-initiators, inhibitors, and pigments, as well as UV lamp irradiance and spectral output. In comparison to clear coat formulations, the presence of pigments may make curing much more complex due to the absorption of the UV radiation by the pigment. Thus, the use of variable wavelength UV sources, along with matching of absorption characteristics of photo-initiators with UV source spectral output, allows for curing of pigmented formulations.

Light sources used for UV curing include arc lamps, such as carbon arc lamps, xenon arc lamps, mercury vapor lamps, tungsten halide lamps, lasers, the sun, sunlamps, and fluorescent lamps with ultra-violet light emitting phosphors. Medium pressure mercury and high pressure xenon lamps have various emission lines at wavelengths which are absorbed by most commercially available photo-initiators. In addition, mercury arc lamps can be doped with iron or gallium. Alternatively, lasers are monochromatic (single wavelength) and can be used to excite photo-initiators which absorb at wavelengths that are too weak or not available when using arc lamps. For instance, medium pressure mercury arc lamps have intense emission lines at 254 nm, 265 nm, 295 nm, 301 nm, 313 nm, 366 nm, 405/408 nm, 436 nm, 546 nm, and 577/579 nm. Therefore, a photo-initiator with an absorbance maximum at 350 nm may not be a efficiently excited using a medium pressure mercury arc lamp, but could be efficiently initiated using a 355 nm Nd:YVO4 (Vanadate) solid-state lasers. Commercial UV/Visible light sources with varied spectral output in the range of 250-450 nm may be used directly for curing purposes; however wavelength selection can be achieved with the use of optical bandpass or longpass filters. Therefore, as described herein, the user can take advantage of the optimal photo-initiator absorbance characteristics.

Regardless of the light source, the emission spectra of the lamp must overlap the absorbance spectrum of the photo-initiator. Two aspects of the photo-initiator absorbance spectrum need to be considered. The wavelength absorbed and the strength of absorption (molar extinction coefficient). By way of example only, the photo-initiators HMPP (2-hydroxy-2-methyl-1-phenyl-propan-1-one) and TPO (diphenyl(2,4,6-trimethylbenzoyl)phosphine oxide) in DAROCUR® 4265 (from Ciba Specialty Chemicals 540 White Plains Road, Tarrytown, N.Y., U.S.A.) have absorbance peaks at 270-290 nm and 360-380 nm, while DAROCUR® 1173 (from Ciba Specialty Chemicals 540 White Plains Road, Tarrytown, N.Y., U.S.A.) have absorbance peaks at 245 nm, 280 nm, and 331 nm, while ESACURE® KTO-46 (from Lamberti S.p.A., Gallarate (VA), Italy) have absorbance peaks between 245 nm and 378 nm, and MMMP in IRGACURE® 907 (from Ciba Specialty Chemicals 540 White Plains Road, Tarrytown, N.Y., U.S.A.) absorbs at 350 nm and IRGACURE® 500 (which is a blend of IRGACURE® 184 (from Ciba Specialty Chemicals 540 White Plains Road, Tarrytown, N.Y., U.S.A.) and benzophenone) absorbs between 300 nm and 450 nm

The addition of pigment to a formulation increases the opacity of the resulting coating and can have an effect on curing abilities. Furthermore, the added pigment can absorb the incident curing radiation and thereby affect the performance of the photo-initiator. Thus, the curing properties of opaque pigmented coatings can depend on the pigment present, individual formulation, irradiation conditions, and substrate reflection. Therefore, consideration of the respective UV/vis absorbance characteristics of the pigment and the photo-initiator can be used to optimize UV curing of pigmented coatings. Generally, photo-initiators used for curing pigmented formulations have a higher molar extinction coefficient between the longer wavelengths (300 nm-450 nm) than those used for curing clear formulations. Although, the presence of pigments can absorb radiation both in the UV and visible light regions, thereby reducing absorption suitable for radiation curing, phosphine oxide type photo-initiators, for example but not limited to mono- and bis-acylphosphine oxide photo-initiators, are effective in pigmented, including, by way of example only, black, UV-curable coating materials. Phosphine oxides also find use as photo-initiators for white coatings, and enable an effective through cure for the compositions described herein.

The mercury gas discharge lamp is the UV source most widely used for curing, as it is a very efficient lamp with intense lines UV-C (200-280 nm) radiation, however it has spectral emission lines in the UV-A (315-400 nm) and in the UV-B (280-513 nm) regions. The mercury pressure strongly affects the spectral efficiency of this lamp in the UV-A, UV-B and UV-C regions. Furthermore, by adding small amounts (doping) of silver, gallium, indium, lead, antimony, bismuth, manganese, iron, cobalt and/or nickel to the mercury as metal iodides or bromides, the mercury spectrum can be strongly changed mainly in the UV-A, but also in the UV-B and UV-C regions. Doped gallium gives intensive lines at 403 nm and 417 nm; whereas doping with iron raises the spectral radiant power in the UV-A region of 358-388 nm by a factor of 2, while because of the presence of iodides, UV-B and UV-C radiation are decreased by a factor of 3 to 7. As discussed above, the presence of pigments in a coating formulation can absorb incident radiation and thereby affect the excitation of the photo-initiator. Thus, it is desirable to tailor the UV source used with the pigment dispersions and the photo-initiator, photo-initiator mixture or photo-initiator/co-initiator mixture used. For instance, by way of example only, an iron doped mercury arc lamp (emission 358-388 nm) is ideal for use with photo-initiator ESACURE® KTO-46 (from Lamberti S.p.A., Gallarate (VA), Italy) (absorbance between 245 and 378 nm).

Multiple lamps with a different spectral characteristics, or sufficiently different in that there is some spectral overlap, can be used to excite mixtures of photo-initiator or mixtures of photo-initiators and co-initiators. For instance, by way of example only, the use of an iron doped mercury arc lamp (emission 358-388 nm) in combination with a pure mercury arc lamp (emission 200-280 nm). The order in which the excitation sources are applied can be adventitiously used to obtain enhanced coating characteristic, such as, by way of example only, hardness, smoothness, shine, adhesion, abrasion resistance, scratch resistance, impact resistance and corrosion resistance. Initial exposure of the coated surface with the longer wavelength source is beneficial, as it traps the nano-filler particle in place and initiates polymerization near the surface, thereby imparting a smooth and adherent coating. Following this with exposure to the higher energy, shorter wavelength radiation enables for a fast cure of the remaining film that has been set in place by the initial polymerization stage.

The time of exposure to each lamp type can be manipulated to enhance the curing of the compositions described herein. One approach used for curing of the compositions described herein used to coat surfaces of wooden objects, is to expose the coated surface to the longer wavelength doped mercury arc lamps for a shorter time than exposure to the shorter wavelength mercury arc lamp. However, this exposure scheme may cause the cured coatings to wrinkle/crinkle. Therefore, other exposure schemes involve identical exposure time for both the short wavelength mercury arc lamp, and the longer wavelength doped mercury arc lamps, or alternatively the exposure time to the longer wavelength doped mercury arc lamp can be longer than the time of exposure for the short wavelength mercury arc lamps. In one embodiment, non-metal substrates that include the present compositions are exposed to a mercury arc lamp.

In further or alternative embodiments, the time period for exposing non-metal products that include a composition provided herein to actinic radiation is less than 2 minutes. In further embodiments, the time period for exposing non-metal products that include a composition provided herein to actinic radiation is less than 1 minute. In further embodiments, the time the time period for exposing non-metal products that include a composition provided herein to actinic radiation is less than 15 seconds.

In some embodiments, non-metal products that include a composition provided herein can optionally be exposed to two sources of actinic radiation. In further or alternative embodiments, the time between the first actinic radiation step and the second actinic radiation step is less than 2 minutes. In further embodiments, the time between the first actinic radiation step and the second actinic radiation step is less than 1 minute. In further embodiments, the time between the first actinic radiation step and the second actinic radiation step is less than 15 seconds.

In further or alternative embodiments, the length of time of the first actinic radiation step is shorter than the length of time of the second actinic radiation step. In further or alternative embodiments, the length of time of the first actinic radiation step is longer than the length of time of the second actinic radiation step. In further or alternative embodiments, the length of time of the first actinic radiation step is identical to the length of time of the second actinic radiation step.

In certain embodiments, provided herein are non-metal products that include the present compositions which exhibit at least one, two, three, four, five, six or all of the following characteristic upon curing: (a) resistance to water or wetting; (b) retention of structural strength; (c) retention of color, brightness, print; (d) resistance to scratch; (e) gloss; (f) retention of writability of pen and/or ink and/or (g) resistance to mold, algae, mildew, bacterial, and/or fungal growth.

In a further or alternative embodiment, cured non-metal products exhibit at least one, two, three, four, five, six, or seven of the following characteristics after exposure to water for at least 1 day: (a) resistance to water or wetting; (b) retention of structural strength; (c) retention of color, brightness, print; (d) resistance to scratch; (e) gloss; (f) retention of writability of pen and/or ink and/or (g) resistance to mold, algae, mildew, bacterial, and/or fungal growth.

### Assemblages, Process Lines, and Factories

In one aspect are assemblages for manufacturing non-metal products, wherein the assemblages include means for curing non-metal substrates that include the present composition(s). In an embodiment, assemblages include an irradiation station that comprises at least one light capable of providing actinic radiation selected from the group consisting of visible radiation, near visible radiation, ultra-violet (UV) radiation, and combinations thereof. In further or alternative embodiments, the irradiation station includes at least one light source capable of providing actinic radiation selected from the group consisting of UV-A radiation, UV-B radiation, UV-C radiation, UV-D radiation, or combinations thereof. In further or alternative embodiments, the irradiation station includes providing actinic radiation in the form of sunlight.

In a further aspect, methods for producing the present compositions are described herein and involve adding the components, for instance, by way of example only, at least one nano-filler; at least one photo-initiator; at least one monomer selected from among acrylates, methacrylates, diacrylates, dimethacrylates, triacrylates and/or trimethacrylates; at least one cross-linkable, silicone acrylate, silicone methacrylate, silicone diacrylate, silicone dimethacrylate, silicone triacrylate and/or silicone trimethacrylate; at least one metal salt; and optionally a pigment, pigment dispersion and/or a third photo-initiator; and using a means for mixing the components together to form a smooth composition. In further or alternative embodiments, the composition may be mixed in or transferred to a suitable container, such as, but not limited to, a can.

In another aspect are assemblages for applying the composition to at least a portion of a surface of a non-metal substrate including a means for applying the present composition to the substrate; a means for irradiating the non-metal substrate including the applied composition with a source of actinic radiation so as to wholly or partially cure the applied surface. Non-metal products produced by the present methods and assemblages exhibit at least one, two, three, four, five, six, or seven of the following characteristics: (a) resistance to water or wetting; (b) retention of structural strength; (c) retention of color, brightness, print; (d) resistance to scratch; (e) gloss; (f) retention of writability of pen and/or ink and/or (g) resistance to mold, algae, mildew, bacterial, and/or fungal growth. Additionally, non-metal products produced by the present methods and assemblages exhibit at least one, two, three, four, five, six, or seven of the following characteristics after exposure to water for at least 1 day: (a) resistance to water or wetting; (b) retention of structural strength; (c) retention of color, brightness, print; (d) resistance to scratch; (e) gloss; (f) retention of writability of pen and/or ink and/or (g) resistance to mold, algae, mildew, bacterial, and/or fungal growth.

In an embodiment, assemblages include means for mixing components of the present compositions. In a further or alternative embodiment, assemblages include means for providing a non-metal substrate. In a further or alternative embodiment, assemblages include means for applying the present composition to a non-metal substrate. In a further or alternative embodiment, assemblages include means for curing non-metal substrates that include applied compositions.

Non-metal substrates may be provided in any manner sufficient to facilitate applying the present compositions to the non-metal substrate. In an embodiment, non-metal substrates are provided on a spindle or in a roll. In another embodiment, non-metal substrates may be laid flatly on a conveyor belt or on a tray. In yet another embodiment, non-metal substrates are hung on a moving line.

Means for curing the non-metal substrates may include irradiating substrates that include the present composition(s) so as to partially or completely cure the surface at an irradiation station. In an embodiment, irradiation and curing is accomplished at a single station so as to not require the transport of the object. In still a further embodiment, the means for applying the composition is located at an application station, wherein the object must be moved from the application station to the irradiation station. In yet a further embodiment, such assemblages further include a means for moving the object from the application station to the irradiation station. In still yet a further embodiment, the means for moving includes a conveyer belt.

In further or alternative embodiments, the irradiation station includes a means for limiting the exposure of actinic radiation to the application station. In yet further or alternative embodiment, assemblages further include a means for rotating the substrate around at least one axis. In yet further or alternative embodiment, assemblages further include a mounting station wherein the substrate to be applied with the composition is attached to a movable unit. In further embodiments, the movable unit is capable of rotating the substrate around at least one axis. In further or alternative embodiments, the movable unit is capable of moving the substrate from the application station to the irradiation station.

In still further or alternative embodiments, such assemblages further include a removal station wherein the completely cured fiber product is removed from the movable unit. In further embodiments, the completely cured fiber product does not require cooling prior to removal from the movable unit.

In further or alternative embodiments, the application station further includes a means for reclaiming composition that is non-adhering to the surface of the non-metal substrate. In still further embodiments, the reclaimed composition is subsequently applied to a different substrate.

In further or alternative embodiments, the assemblage includes a source of actinic radiation selected from the group consisting of visible radiation, near visible radiation, ultra-violet (UV) radiation, and combinations thereof. In further or alternative embodiments, the assemblage includes multiple sources of actinic radiation. In further or alternative embodiments, the irradiation station includes an arrangement of mirrors. In certain embodiments, the irradiation station includes sunlight.

In further embodiments, processes further include attaching the non-metal substrate to a rotatable spindle prior to the application step. In further or alternative embodiments, such processes further include moving the conveying means after attaching the object to the rotatable spindle so as to locate the object near an application station. In further embodiments, such processes further include applying the present composition at the application station as the spindle holding the object rotates. In further embodiments, the conveying means includes a conveyer belt.

In further or alternative embodiments, the irradiation station includes a curing chamber containing a first actinic radiation source and a second actinic radiation source.

In further embodiments, such processes further include moving the completely cured product via the conveying means outside the curing chamber wherein the product is packed for storage or shipment.

In further or alternative embodiments, the irradiation station includes an arrangement of mirrors such that the applied surface is cured in three dimensions. In further or alternative embodiments, the irradiation station includes an arrangement of light sources such that the coated surface is cured in three dimensions. In further embodiments, each light source emits different spectral wavelength ranges. In further embodiments, the different light sources have partially overlapping spectral wavelength ranges.

In another aspect are production lines for applying at least a portion of a surface of a non-metal substrate with the present composition including a process which comprises attaching the substrate onto a conveying means; applying the present composition at an application station onto the surface of the non-metal substrate; moving the applied substrate via the conveying means to an irradiation station; irradiating and partially or wholly curing the applied surface at the irradiation station with actinic radiation; wherein the fiber product upon curing exhibit at least one, two, three, four, five, six, or seven of the following characteristics: (a) resistance to water or wetting; (b) retention of structural strength; (c) retention of color, brightness, print; (d) resistance to scratch; (e) gloss; (f) retention of writability of pen and/or ink and/or (g) resistance to mold, algae, mildew, bacterial, and/or fungal growth. Alternatively or in conjunction, non-metal products produced by the present production lines exhibit at least one, two, three, four, five, six, or seven of the following characteristics after exposure to water for at least 1 day: (a) resistance to water or wetting; (b) retention of structural strength; (c) retention of color, brightness, print; (d) resistance to scratch; (e) gloss; (f) retention of writability of pen and/or ink and/or (g) resistance to mold, algae, mildew, bacterial, and/or fungal growth.

In another aspect are facilities or factories for producing non-metal products including at least one process line for applying at least a portion of a surface of a non-metal substrate with the present composition including a process which comprises attaching the substrate onto a conveying means; at least one process line for applying the present composition at an application station onto the surface of the non-metal substrate; at least one process line for moving the applied substrate via the conveying means to an irradiation station; and at least one process line for irradiating and partially or wholly curing the applied surface at the irradiation station with actinic radiation; wherein the non-metal product upon curing exhibit at least one, two, three, four, five, six, or seven of the following characteristics: (a) resistance to water or wetting; (b) retention of structural strength; (c) retention of color, brightness, print; (d) resistance to scratch; (e) gloss; (f) retention of writability of pen and/or ink and/or (g) resistance to mold, algae, mildew, bacterial, and/or fungal growth. Alternatively or in conjunction, non-metal products produced by the present production lines exhibit at least one, two, three, four, five, six, or seven of the following characteristics after exposure to water for at least 1 day: (a) resistance to water or wetting; (b) retention of structural strength; (c) retention of color, brightness, print; (d) resistance to scratch; (e) gloss; (f) retention of writability of pen and/or ink and/or (g) resistance to mold, algae, mildew, bacterial, and/or fungal growth.

### Non-Metal Products

Non-metal products provided herein are non-metal substrates including the present compositions. In further or alternative embodiments, the entire surface or just a portion of the surface of non-metal products include the present compositions. In further or alternative embodiments, the present composition may be sparingly applied or heavily applied to the non-metal substrate. In further or alternative embodiments, non-metal products that include the present compositions may be uncured, partially cured, or completely cured.

In one aspect, the present composition upon curing provides at least one, two, three, four, five, six, or seven of the following characteristics to the non-metal product: (a) resistance to water or wetting; (b) retention of structural strength; (c) retention of color, brightness, print; (d) resistance to scratch; (e) gloss; (f) retention of writability of pen and/or ink and/or (g) resistance to mold, algae, mildew, bacterial, and/or fungal growth. In an embodiment, non-metal products exhibits at least one, two, three, four, five, six, or seven of the following characteristics: (a) resistance to water or wetting; (b) retention of structural strength; (c) retention of color, brightness, print; (d) resistance to scratch; (e) gloss; (f) retention of writability of pen and/or ink and/or (g) resistance to mold, algae, mildew, bacterial, and/or fungal growth.

In another aspect, the present composition upon curing provides at least one, at least two, at least three, at least four, at least five, at least six, or at least seven of the following characteristics to the non-metal product after exposure to water: (a) resistance to water or wetting; (b) retention of structural strength; (c) retention of color, brightness, print; (d) resistance to scratch; (e) gloss; (f) retention of writability of pen and/or ink and/or (g) resistance to mold, algae, mildew, bacterial, and/or fungal growth.

In further or alternative embodiments, non-metal products exhibit the following characteristics after exposure to water for at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 40, 45, 50, 55, and 60 days: (a) resistance to water or wetting; (b) retention of structural strength; (c) retention of color, brightness, print; (d) resistance to scratch; (e) gloss; (f) retention of writability of pen and/or ink and/or (g) resistance to mold, algae, mildew, bacterial, and/or fungal growth.

Exposure to water can constitute partial or complete exposure to water. Alternatively, exposure to water can include exposure to moisture, such as mist, fog, and pressurized water vapor. Alternatively, exposure to water can constitute exposure to water-containing weather, such as rain, drizzle, snow, sleet, fog, hail, and the like. Alternatively, exposure to water can constitute partial or complete submersion of an object in water. Alternatively, exposure to water can be continuous, consecutive, or intermittent. For example, objects exposed to water can be submerged underwater or laying in a pool of water.

Exposure to any type of water is contemplated as being within the scope of the present disclosure. Pure water, ionized water, de-ionized water, filtered water, salt water, rain water, mineral water, river water, mud water, enriched water, tap water, and spring water are all embraced within the present disclosure.

Examples of cured paper products is disclosed in U.S. patent application Ser. No. 11/234,672, paragraphs [00143] through [00146], incorporated herein by reference.

### Testing the Cured Coating Compositions on Non-Metal Products

The present compositions possess excellent durability and are suitable for surfaces of non-metal products which encounter physical wearing or exposure to various weather conditions. Various mechanical properties of solid coatings and the various testing methods for them is described in “Mechanical Properties of Solid Coatings” Encyclopedia of Analytical Chemistry, John Wiley & Sons, 2000, which is herein incorporated by reference in its entirety. Descriptions for the following tests are provided by way of example only.

For example, the compositions and methods described herein provide an improved cured product that exhibits improvement in at least one of the following properties: (a) resistance to water or wetting; (b) retention of structural strength; (c) retention of color, brightness, print; (d) resistance to scratch; (e) gloss; (f) retention of writability of pen and/or ink and/or (g) resistance to mold, algae, mildew, bacterial, and/or fungal growth.

For example, the compositions and methods described herein provide an improved cured product that exhibits improvement in at least two of the following properties: (a) resistance to water or wetting; (b) retention of structural strength; (c) retention of color, brightness, print; (d) resistance to scratch; (e) gloss; (f) retention of writability of pen and/or ink and/or (g) resistance to mold, algae, mildew, bacterial, and/or fungal growth.

Retention of brightness prevents discoloration, such as darkening or yellowing, of a material. Representative tests for determining retention of brightness include spectrophotometric tests, such as optical absorption test for brightness (wavelength=457 nm) and/or luminance (wavelength=555 nm), for example.

Retention of ink or pencil writing refers to the ability of ink or pencil writing to be retained on a material. Retention of ink or pencil writing prevents bleeding, fading, and/or streaking on a material. Representative tests for determining retention of ink or pencil writing include spectrophotometric tests, such as the Ink Elimination (IE) test and the Effective Residual Ink Concentration (ERIC) test, for example.

Retention of print refers to the ability of print to be retained on a material. Representative prints include various ink prints, such as labels, logos, and the like. Retention of print prevents bleeding, fading, and/or streaking on a material. Representative tests for determining retention of print include various spectral photometric tests.

Retention of structural strength refers to the ability of a material to retain its physical and structural integrity, strength, or durability. Retention of structural strength prevents tearing, ripping, or breaks. Representative mechanical tests for determining retention of structural strength include manual inspection, folding endurance, and tensile strength, for example. Spectral photometric tests may also be employed to determine retention of structural strength.

Retention of writability of pencil and/or ink refers to the ability of a material to retain its ability to be written upon by any type of pencil or any source of ink, such as a pen or printer. Writability depends on the absorbency of a material.

Resistance to the growth of mold, bacteria, and/or fungus refers to the ability of the material to inhibit or slow down the growth of these of mold, bacteria, and/or fungus. This characteristic can be tested by streaking a mold, bacteria, and/or fungus on the coating and/or cured fiber product and comparing the growth of the mold, bacteria, and/or fungus relative to an uncoated and/or uncured non-metal product. The coated and cured non-metal products described herein, in addition to retaining structural integrity and/or structural strength, also resist the growth of mold, bacteria, and/or fungus even when the non-metal product is exposed to mold, bacteria, and/or fungus in water.

The invention is described in more detail in the following examples. These examples are provided by way of illustration and are not intended to limit the invention in any way.

### EXAMPLES

### Example 1

### Formulation for Clear Composition

In certain embodiments, a clear, thixotropic composition is prepared by using a two-step procedure. In the first step, a pre-mix composition is prepared by mixing 21.45% by weight of tetrahydrofurfuryl acrylate; 11.98% by weight of isobornyl acrylate; 12.56% by weight of 1,4-butanediol dimethacrylate; 13.62% by weight of 2-phenoxyethyl acrylate; 34.91% by weight of Nanocryl® C-155 (available from Hanse Chemie, Germany); 2.00% by weight of Irgacure® 500 (available from Ciba Specialty Chemicals); 3.43% by weight of Irgacure® 184 (available from Ciba Specialty Chemicals); and 0.05% by weight of Tego Rad® 2100 (available from Tego Chemie). These components are thoroughly mixed by a magnetic or overhead mixer until a homogeneous composition is produced.

In additional embodiments, the first step of preparing clear, thixotropic compositions includes mixing the following components (i.e. the pre-mix):

| | | |
|---|---|---|
| tetrahydrofurfuryl acrylate | 11–31% | by weight |
| isobornyl acrylate | 2–22% | by weight |
| 1,4-butanediol dimethacrylate | 3–40% | by weight |
| 2-phenoxyethyl acrylate | 4–40% | by weight |
| Nanocryl ® C-155 | 25–50% | by weight |
| Irgacure ® 184 | 2–10% | by weight |
| Irgacure ® 500 | 0.5–10% | by weight |
| TEGO ® Rad 2100 | 0.01–2.0% | by weight |

The second step of preparing clear, thixotropic compositions includes adding about 2.4% by weight of Genocure® LTM (available from Rahn USA Corporation), and about 0.4% of LiCl to about 97.2% by weight of the pre-mix composition prepared in step one. The mixture is mixed at a sufficient speed to ensure an even distribution of Genocure® LTM and LiCl. Mixing is performed until a desired consistency is obtained (thixotropic but not sticky).

### Example 2

### Formulation for Pigmented Composition

In certain embodiments, a pigmented, thixotropic composition is prepared in a two step procedure. In the first step, a pre-mix is prepared by mixing 19.46% by weight of tetrahydrofurfuryl acrylate; 10.86% by weight of isobornyl acrylate; 11.40% by weight of 1,4-butanediol dimethacrylate; 12.31% by weight of 2-phenoxyethyl acrylate; 31.6% by weight of Nanocryl® C-155 (available from Hanse Chemie, Germany); 1.99% by weight of Irgacure® 500 (available from Ciba Specialty Chemicals); 3.08% by weight of Irgacure® 184 (available from Ciba Specialty Chemicals); 0.05% by weight of Tego® Rad 2100 (available from Tego Chemie); 8.42% by weight of PC 9003, and 0.83% by weight of Lucerin® TPO. These components are thoroughly mixed by a magnetic or overhead mixer until a homogeneous composition is produced.

In certain embodiments, the first step for preparing pigmented, thixotropic compositions includes preparing a pre-mix by mixing the following components:

| | | |
|---|---|---|
| tetrahydrofurfuryl acrylate | 11–31% | by weight |
| isobornyl acrylate | 2–22% | by weight |
| 1,4-butanediol dimethacrylate | 3–40% | by weight |
| 2-phenoxyethyl acrylate | 4–40% | by weight |
| Nanocryl ® C-155 | 25–45% | by weight |
| Irgacure ® 184 | 2–6% | by weight |
| Irgacure ® 500 | 0.5–4.0% | by weight |
| TEGO ® Rad 2100 | 0.01–2.0% | by weight |
| PC 9003 | 1–12% | by weight |
| Lucerin ® TPO | 0.5–5% | by weight |

The second step for preparing pigmented, thixotropic compositions includes mixing in about 2.4% by weight of Genocure® LTM (available from Rahn USA Corporation), and about 0.4% of LiCl to about 97.2% by weight of the pre-mix from step one. The mixture is mixed at a sufficient speed to ensure an even distribution of Genocure® LTM and LiCl. Mixing is performed until a desired consistency is obtained (thixotropic but not sticky).

### Example 3

### Procedure for Making Clear Compositions

In other embodiments, the following procedure is used for making compositions provided herein. A further embodiment is the procedure used for making the present compositions. The components of the composition are mixed under air, as the presence of oxygen prevents premature polymerization. It is desired that exposure light be kept to a minimum, in particularly the use of sodium vapor lights should be avoided. However, the use of darkroom lighting may be an option. The components used in the manufacture of the composition which come in contact with monomers and coating mixture, such as mixing vessels and mixing blades, should be made of plastic, including polyethylene or polypropylene. Polystyrene and PVC should be avoided, as the monomers and mixture will dissolve them. In addition, contact of the monomers and mixture with mild steel, alloys of copper, acids, bases, and oxidizers should be avoided. Furthermore, brass fittings must be avoided, as they will cause premature polymerization or gelling. Adequate mixing of the composition can be obtained after about 1-3 hours using a ⅓ horse power (hp) mixer and a 50 gallon cylindrical tank. Smaller quantities, up to 5 gallons, can be adequately mixed after about 3 hours using a laboratory mixer ( 1/15- 1/10 hp). Round walled vessels are desired as this avoids accumulation of materials in corners and any subsequent problems associated with incomplete mixing. Another parameter is that the mixers blades should be placed off of the bottom of the mixing vessel, at a distance of one half of the diameter of the mixer. The monomers are added to the mixing vessel first, and if necessary the monomers are gently warmed to aid in handling. Monomers should not be heated over 50° C., therefore if warning is needed the use of a temperature controlled heating oven or heating mantle is recommended. No heating is necessary for the formation of clear coatings. Band heaters should be avoided. Colloidal suspensions are added next, in any order, followed by any ester/monomer adhesion promoters. Photo-initiators are added last to minimize the time the complete composition is exposed to light. With the mixing vessel shielded from light exposure, the mixing is then carried out after all the components are added. After mixing, air bubbles may be present and the composition may appear cloudy. These bubbles rapidly dissipate, leaving a homogeneous composition. As a final step, prior to removing the coating composition from the mixing vessel, the bottom of the mixing vessel is scraped to see if any un-dissolved material is present. This is done as a precaution to ensure thorough mixing has taken place. If the composition is thoroughly mixed, then the coating composition is filtered through a 1 micron filter using a bag filter. The composition is then ready for use in the next step, which involves further mixing in the same mixing vessel. To the composition is added at least one metal salt, such as, for example, LiCl or CaCl₂, and optionally at least one phosphine oxide type photo-initiator, such as, for example Genocure® LTM. A fast mix aids in dispersing the metal salt throughout the composition in order to avoid any clumping that might occur. The composition is mixed for about 3-5 hours at room temperature. The thixotropic composition is ready for use. If the thixotropic compositions becomes less viscous upon standing, the composition is mixed to attain a desirable, more viscous state. Addition of water to the compositions provided herein produces an increase in viscosity. To produce a white composition without the addition of pigments or pigment dispersion, the composition is heated slightly, approximately 74° C., during the final mixing step after the addition of the metal salt and phosphine oxide photo-initiator.

### Example 4

### Procedure for Making Pigmented Compositions

In some embodiments, pigmented compositions are prepared by following the following procedure. In these embodiments, a mixer of sufficient power and configuration is used to create laminar flow and efficiently bring the pigment dispersions against the blades of the mixer. For small laboratory quantities below 400 mL, a laboratory mixer or blender is sufficient, however for quantities of up to half of a gallon a 1/15- 1/10 hp laboratory mixer can be used, but mixing will take several days. For commercial quantities, a helical or saw-tooth mixer of at least 30 hp with a 250 gallon round walled, conical bottomed tank may be used. To make a pigmented composition, a clear composition is mixed first, see Example 3. The pigment dispersion mixtures are premixed prior to addition to the clear composition as this ensures obtaining the correct color. The premixing of the pigments dispersions is easily achieved by shaking the pigments dispersion in a closed container, while wearing a dust mask. The fillers, the premixed pigments/pigment dispersions, and solid photo-initiator are then added to the clear composition and mixed for about 1½ to 2 hours. Completeness of mixing is determined by performing a drawdown and checking for un-dissolved pigment. This is accomplished by drawing off a small quantity of the pigmented mixture from the bottom of the mixing tank and applying a thin coating onto a surface. This thin coating is then examined for the presence of any pigment which had not dissolved. The mixture is then run through a 100 mesh filter. A thoroughly mixed pigmented composition will show little or no un-dissolved pigment. The pigmented composition is then placed in the same mixing vessel and further mixing is performed. To the pigmented composition is added at least one metal salt, such as, for example, LiCl or CaCl₂, and optionally at least one phosphine oxide type photo-initiator, such as, for example Genocure® LTM. A fast mix aids in dispersing the metal salt throughout the composition in order to avoid any clumping that might occur. The pigmented composition is mixed for about 3-5 hours at room temperature. The thixotropic, pigmented composition is ready for use. If the thixotropic compositions becomes less viscous upon standing, the composition is mixed to attain a desirable, more viscous state. Addition of water to the compositions provided herein produces an increase in viscosity.

### Example 5

### Process for Applying Compositions to the Surface of Non-Metal Substrates and Curing the Applied Compositions

Compositions provided herein, with or without metal salts, are applied to fiber substrates as disclosed in U.S. patent application Ser. No. 11/234,672, paragraphs [00162] through [00176], incorporated herein by reference. Applying thixotropic compositions provided herein to non-metal objects is achieved by any suitable means, such as, for example, wiping, smearing, rolling, dipping, brushing, or pouring the compositions onto the non-metal objects. After applying the composition to the non-metal object, the coated or partially coated object is then exposed to a source of UV radiation to effect curing. For example, exposure of the coated object to one mercury arc lamp is sufficient to effect curing. For compositions of Example 2, exposure of the coated object to two mercury arc lamps is sufficient to effect curing, where one lamp can be a mercury arc lamp and the other lamp can be a mercury arc lamp doped with iron, to ensure proper curing. Generally, the time of exposure to the doped mercury arc lamp is less than the time of exposure to the pure mercury arc lamp. Both lamps are turned off and the cured paper is then removed. Alternatively, exposure of the coated object to sunlight is sufficient to effect curing, although slightly longer cure times are observed than if a mercury arc lamp or a mercury arc lamp doped with iron is used.

### Example 6

### Preparation of a Snow Melting Mat

A 50 foot long by 3 foot wide sheet of paper substrate is impregnated with UV curable waterproofing formulation with nanoparticles by the methods of application known in the art such as spraying, rolling, brushing, wiping, or squeeging the paper in the formulation described in Example 1. A mixture of 15% powdered silica gel, 20% NaCl, and 65% carboxylate salt is prepared. This mixture is applied to the top side of the paper substrate. The bottom side of the paper is then treated with a salt mixture of 50% NaCl and 50% CaCl₂. The paper is cured using sunlight for 8 hours. The treated sheet is then rolled, packaged, and sold in roll format, to be cut to size as needed.

### Example 7

### Preparation of Snow Melting Mat Using Recycled Paper

A paper substrate derived from 100% recycled paper is impregnated with a UV curable waterproofing formulation with nanoparticles by the methods of application known in the art such as spraying, rolling, brushing, wiping, or squeeging in the following formulation: 29% tetrahydrofurfuryl acrylate, 17% isobornyl acrylate, 18% 1,4-butanediol dimethacrylate, 5% 2-phenoxyethyl acrylate, 25% Nanocryl® C-155, 4% Irgacure® 184, 2% Irgacure® 500, and 0.1% TEGO® Rad 2100. The top side of the paper is then treated with a mixture of 25% powdered silica gel and 75% NaCl. This is applied to the top side of the paper substrate. The paper substrate is cured by exposure to two mercury arc lamps for 30 minutes. The bottom side of the paper is then treated with 100% NaCl.

### Example 8

### Method of Melting Snow Using a Snow Melting Mat Prepared from Recycled Paper

A snow melting mat prepared as described in Example 6 is placed on a section of a sidewalk having 2 inches of snow near the entry of a building. Pedestrians are allowed to walk on the snow mat. After 30 minutes, the snow is completely melted.

### Example 9

### Preparation and Use of a Freezer Defrosting Mat

A flexible, non-corrosive mat to quicken freezer defrosting time is prepared using the following method. A piece of 1.5 foot by 2 foot recycled paper is obtained. The top of the paper is impregnated with a UV curable waterproofing formula with nanoparticles, prepared as described in Example 2. A mixture of organic salts is prepared and applied to the bottom of the mat. The material is cured by exposure of the coated mat to two mercury arc lamps for 10 minutes. The mat is then stored prior to use.

To defrost a freezer, the mat is placed on the floor of the freezer space. After 30 minutes, the ice under the mat is completely melted. The area is wiped with a clean cloth towel to minimize the chances of freezer corrosion due to the presence of salt. By use of this method, the freezer defrosting time is greatly reduced.

### Example 10

### Preparation and Use of a Vehicle Windshield Cover Mat

A flexible cover for a car windshield is prepared by cutting a sheet of recycled paper to approximately 6 inches wider and longer than the windshield to be covered. The bottom side of the paper is impregnated with UV curable waterproofing formulation with nanoparticles. The top of the paper is treated with a mixture of 20% powdered silica gel and 80% NaCl. The coated cover is cured with a combination of two lamps—a mercury arc lamp and a mercury arc lamp doped with iron for 40 minutes. After curing, small I” by 1” magnets are glued to the paper sheet every 6 inches using an adhesive. The sheeting is folded back over the magnet and closed with an adhesive to form a seam.

The cover is placed on the windshield of a car that is parked in a location that is likely to accumulate snow and or ice. The magnets are positioned to attach to the car body, without damaging the paint surface on the car. The cover is left on the car as long as it is parked. Prior to driving the car, the cover is removed, shaken to remove excess moisture, and folded for storage. By use of this method, very little snow or ice becomes attached to the windshield surface.

### Example 11

### Preparation and Use of Insect Repellant Shelf Paper

The compositions described herein can also be used to prepare sheeting material to deter insects in storage shelving. A 25 foot sheet of a recycled fiber substrate is obtained. The top side of the fiber sheet is impregnated with UV curable waterproofing formulation as described in Examples 1 and 3. The formulation is applied to the top side of the fiber substrate and cured as described in Example 5.

To cover the bottom side of the fiber substrate, a mixture of 40% powdered silica gel, 20% borax, and 40% boric acid is prepared. This mixture is applied to the bottom surface of the fiber substrate. The resulting sheet is cured using a mercury arc lamp plus a mercury arc lamp doped with iron for 1 hour. The sheet is then rolled into a 25 foot roll and stored until needed. The rolls are cut to shape as needed and applied to the top surface of shelving material. An experimental control shelf paper sample is prepared, which is, lacking in the silica gel, borax, and boric acid mixture of the bottom shelf, but which has the top layer and the adhesive as above. Equal amounts of foodstuffs (flour, pasta, grains) are placed on the shelving in non-airtight containers in a warehouse environment. The shelving is stored at room temperature for 6 months. After 6 months, 1 year, and 1.5 years, the number of insects present both on the shelves and in the foodstuffs is measured. By use of this method, the insect-resistant treated shelves and the foodstuff samples placed on the shelves have only about 10% of the insect contamination of the untreated shelves.

While the present disclosure has been described in connection with an embodiment, it is not intended to limit the scope of the present disclosure to the particular form set forth, but on the contrary, it is intended to cover such alternatives, modifications, and equivalents as may be included within the spirit and scope of the present disclosure as defined by the appended claims.

What is claimed is:

1. A coated mat comprising:
a sheet of a fibrous substrate;
a coated top layer; and
a coated bottom layer,
wherein the coating comprises:
(a) SiO₂ nano-fillers;
(b) a benzoyldiphenylphosphine oxide photo-initiator and an α-hydroxyketone photo-initiator;
(c) tetrahydrofurfuryl acrylate;
(d) at least one acrylate, methacrylate, diacrylate, dimethacrylate, triacrylate and/or trimethacrylate monomer, wherein the acrylate is other than tetrahydrofurfuryl acrylate, in an amount of about 2% by weight up to about 80% by weight;
(e) a cross-linkable, silicone acrylate, silicone methacrylate, silicone diacrylate, silicone dimethacrylate, silicone triacrylate and/or silicone trimethacrylate;
(f) at least one metal salt comprising:
a cation selected from among Li⁺, Na⁺, K⁺, Mg²⁺, Ca²⁺, Al³⁺, Zn²⁺, Mn²⁺, and Ag⁺; and
an anion selected from among F⁻, Cl⁻, Br⁻, I⁻, CO₃²⁻, ClO₄⁻ and NO₃⁻; and
(g) optionally, a pigment, pigment dispersion and/or a third photo-initiator;
wherein the composition is:
(i) actinic-radiation curable; and
(ii) thixotropic with an apparent viscosity at room temperature greater than about 5000 centipoise.

2. The coated mat of claim 1, wherein the fibrous substrate comprises recycled paper.

3. The coated mat of claim 2, wherein coating is impregnated into the fibrous substrate.

4. The coated mat of claim 1, further comprising silica gel.

5. The coated mat of claim 1, further comprising at least one salt.

6. The coated mat of claim 5, wherein the at least one salt is selected from the group consisting of NaCl, CaCl₂, MgCl₂, and an organic salt.

7. The coated mat of claim 6, wherein the salt is an organic salt.

8. The coated mat of claim 7, wherein the organic salt is a carboxylate salt.

9. The coated mat of claim 1, wherein the mat is formed into an item selected from the group consisting of a snow melting mat, a freezer defrosting mat, a windshield cover, and shelf paper.

10. A method of preparing a mat for melting snow, comprising:
coating or impregnating a mat with UV curable waterproofing formulation comprising:
(a) SiO₂ nano-fillers;
(b) a benzoyldiphenylphosphine oxide photo-initiator and an α-hydroxyketone photo-initiator;
(c) tetrahydrofurfuryl acrylate;
(d) at least one acrylate, methacrylate, diacrylate, dimethacrylate, triacrylate and/or trimethacrylate monomer, wherein the acrylate is other than tetrahydrofurfuryl acrylate, in an amount of about 2% by weight up to about 80% by weight;
(e) a cross-linkable, silicone acrylate, silicone methacrylate, silicone diacrylate, silicone dimethacrylate, silicone triacrylate and/or silicone trimethacrylate;
(f) at least one metal salt comprising:
a cation selected from among Li⁺, Na⁺, K⁺, Mg²⁺, Ca²⁺, Al³⁺, Zn²⁺, Mn²⁺, and Ag⁺; and
an anion selected from among F⁻, Cl⁻, Br⁻, I⁻, CO₃²⁻, ClO₄⁻ and NO₃⁻; and
(g) optionally, a pigment, pigment dispersion and/or a third photo-initiator;
wherein the composition is:
(i) actinic-radiation curable; and
(ii) thixotropic with an apparent viscosity at room temperature greater than about 5000 centipoise; and
coating at least one side of the mat with a composition comprising:
from about 0% to about 25% powdered silica gel; and
from about 75% to about 100% salt.

11. A freezer defrosting mat, comprising:
a fibrous substrate;
a coating layer, wherein the coating comprises a UV curable waterproofing formulation comprising:
(a) SiO₂ nano-fillers;
(b) a benzoyldiphenylphosphine oxide photo-initiator and an α-hydroxyketone photo-initiator;
(c) tetrahydrofurfuryl acrylate;
(d) at least one acrylate, methacrylate, diacrylate, dimethacrylate, triacrylate and/or trimethacrylate monomer, wherein the acrylate is other than tetrahydrofurfuryl acrylate, in an amount of about 2% by weight up to about 80% by weight;
(e) a cross-linkable, silicone acrylate, silicone methacrylate, silicone diacrylate, silicone dimethacrylate, silicone triacrylate and/or silicone trimethacrylate;
(f) at least one metal salt comprising:
a cation selected from among Li⁺, Na⁺, K⁺, Mg²⁺, Ca²⁺, Al³⁺, Zn²⁺, Mn²⁺, and Ag⁺; and
an anion selected from among F⁻, Cl⁻, Br⁻, I⁻, CO₃²⁻, ClO₄⁻ and NO₃⁻; and
(g) optionally, a pigment, pigment dispersion and/or a third photo-initiator;
wherein the composition is:
(i) actinic-radiation curable; and
(ii) thixotropic with an apparent viscosity at room temperature greater than about 5000 centipoise; and
a coating layer comprising at least one salt.

12. The freezer defrosting mat of claim 22, wherein the at least one salt is an organic salt.

13. A vehicle windshield cover to prevent snow or ice buildup, comprising:
a fibrous substrate;
a coating layer, wherein the coating comprises a UV curable waterproofing formulation comprising:
(a) SiO₂ nano-fillers;
(b) a benzoyldiphenylphosphine oxide photo-initiator and an α-hydroxyketone photo-initiator;
(c) tetrahydrofurfuryl acrylate;
(d) at least one acrylate, methacrylate, diacrylate, dimethacrylate, triacrylate and/or trimethacrylate monomer, wherein the acrylate is other than tetrahydrofurfuryl acrylate, in an amount of about 2% by weight up to about 80% by weight;
(e) a cross-linkable, silicone acrylate, silicone methacrylate, silicone diacrylate, silicone dimethacrylate, silicone triacrylate and/or silicone trimethacrylate;
(f) at least one metal salt comprising:
a cation selected from among Li⁺, Na⁺, K⁺, Mg²⁺, Ca²⁺, Al³⁺, Zn²⁺, Mn²⁺, and Ag⁺; and
an anion selected from among F⁻, Cl⁻, Br⁻, I⁻, CO₃², ClO₄⁻ and NO₃⁻; and
(g) optionally, a pigment, pigment dispersion and/or a third photo-initiator;
wherein the composition is:
(i) actinic-radiation curable; and
(ii) thixotropic with an apparent viscosity at room temperature greater than about 5000 centipoise; and
a coating layer comprising from about 0% to about 25% powdered silica gel and about 75% to about 100% salt.

14. The vehicle windshield cover of claim 13, further comprising a means to attach the vehicle windshield cover to the windshield.

15. The vehicle windshield cover of claim 25, wherein the means to attach the vehicle windshield cover is by use of multiple magnets attached near the edges of the windshield cover.

16. An insect-resistant liner for lining shelves, comprising
a fibrous substrate;
a coating layer, wherein the coating comprises a UV curable waterproofing formulation comprising:
(a) SiO₂ nano-fillers;
(b) a benzoyldiphenylphosphine oxide photo-initiator and an α-hydroxyketone photo-initiator;
(c) tetrahydrofurfuryl acrylate;
(d) at least one acrylate, methacrylate, diacrylate, dimethacrylate, triacrylate and/or trimethacrylate monomer, wherein the acrylate is other than tetrahydrofurfuryl acrylate, in an amount of about 2% by weight up to about 80% by weight;
(e) a cross-linkable, silicone acrylate, silicone methacrylate, silicone diacrylate, silicone dimethacrylate, silicone triacrylate and/or silicone trimethacrylate;
(f) at least one metal salt comprising:
a cation selected from among Li⁺, Na⁺, K⁺, Mg²⁺, Ca²⁺, Al³⁺, Zn²⁺, Mn²⁺, and Ag⁺; and
an anion selected from among F⁻, Cl⁻, Br⁻, I, CO₃², ClO₄⁻ and NO₃—; and
(g) optionally, a pigment, pigment dispersion and/or a third photo-initiator;
wherein the composition is:
(i) actinic-radiation curable; and
(ii) thixotropic with an apparent viscosity at room temperature greater than about 5000 centipoise; and
a coating layer comprising
from about 0% to about 100% powdered silica gel;
from about 0% to about 100% borax; and
from about 0% to about 100% boric acid.

17. A method of deterring insect infestation in shelving, comprising lining the shelving with the insect-resistant liner of claim 16.

18. The method of claim 17, wherein the shelving is foodstuff shelving.
